(19) United States
(12) Patent Application Publication
(10) Pub. No.: US 2017/0363736 A1
(43) Pub. Date: Dec. 21, 2017

(54) RADAR DEVICE AND CONTROL METHOD OF RADAR DEVICE

(71) Applicant: FUJITSU TEN LIMITED, Kobe-shi (JP)

(72) Inventors: Shozo KAINO, Kobe-shi (JP); Shinya AOKI, Kobe-shi (JP)

(73) Assignee: FUJITSU TEN LIMITED, Kobe-shi (JP)

(21) Appl. No.: 15/609,878

(22) Filed: May 31, 2017

(30) Foreign Application Priority Data
Jun. 17, 2016 (JP) 2016-120884

(51) Int. Cl. G01S 13/93; G01S 13/32; G01S 7/41

(52) U.S. Cl. CPC G01S 13/931; G01S 7/411; G01S 13/32

(57) ABSTRACT

A radar device according to the embodiments includes a deriving unit and a determining unit. The deriving unit derives, based on a received signal acquired by receiving a reflected wave obtained by reflecting a radar transmission wave transmitted to a periphery of an own vehicle on a target located on the periphery, a parameter related to the target and a detection distance of the target. The determining unit determines, from a given characteristic of the parameter and the parameter and the detection distance derived by the deriving unit, whether the target existing in a traveling direction of the own vehicle is a target that collides with the own vehicle when the own vehicle advances in the traveling direction or a target that does not collide with the own vehicle when the own vehicle advances in the traveling direction.

### CROSS-REFERENCE TO RELATED APPLICATION

This application is based upon and claims the benefit of priority of the prior Japanese Patent Application No. 2016-120884, filed on Jun. 17, 2016, the entire contents of which are incorporated herein by reference.

### FIELD

The embodiments discussed herein are directed to a radar device and a control method of the radar device.

### BACKGROUND

Conventionally, a radar device provided in the front side etc. of the body of a vehicle outputs transmission waves within the external transmission range of the vehicle, receives reflected waves from a target to derive target data including position information etc. of the target, and discriminates a stationary vehicle etc. located in front of the vehicle on the basis of the target data. Then, a vehicle control device provided in the vehicle acquires information related to the stationary vehicle etc. from the radar device, controls the behavior of the vehicle on the basis of the information, and avoids a crash against the stationary vehicle etc., for example, to provide secure and comfortable traveling to a user of the vehicle (see Japanese Laid-open Patent Publication No. 2016-006383, for example).

However, the above conventional technology has a problem that a discriminant precision between a stationary vehicle and an object other than a stationary vehicle is insufficient and thus the object other than the stationary vehicle is incorrectly detected as a stationary vehicle.

### SUMMARY

A radar device according to the embodiments includes a deriving unit and a determining unit. The deriving unit derives, based on a received signal acquired by receiving a reflected wave obtained by reflecting a radar transmission wave transmitted to a periphery of an own vehicle on a target located on the periphery, a parameter related to the target and a detection distance of the target. The determining unit determines, from a given characteristic of the parameter and the parameter and the detection distance derived by the deriving unit, whether the target existing in a traveling direction of the own vehicle is a target that collides with the own vehicle when the own vehicle advances in the traveling direction or a target that does not collide with the own vehicle when the own vehicle advances in the traveling direction.

### BRIEF DESCRIPTION OF DRAWINGS

A more complete appreciation of the present application and many of the attendant advantages thereof will be readily obtained as the same becomes better understood by reference to the following detailed description when considered in connection with the accompanying drawings, wherein:

FIG. 1 is a schematic diagram illustrating the outline of target detection performed by a radar device according to a first embodiment;

FIG. 2 is a diagram illustrating the configuration of the radar device according to the first embodiment;

FIG. 3 is a diagram illustrating a relationship between a transmission wave and a reflected wave and a beat signal;

FIG. 4A is a diagram explaining peak extraction in an up zone;

FIG. 4B is a diagram explaining peak extraction in a down zone;

FIG. 5 is a diagram conceptually illustrating an angle estimated by an azimuth calculation process as an angle spectrum;

FIG. 6A is a diagram explaining pairing based on azimuth angles and angle powers in up and down zones;

FIG. 6B is a diagram explaining a pairing result;

FIG. 7 is a diagram illustrating a relationship between an angle power and a distance of a truck;

FIG. 8 is a diagram explaining average lateral position movement amount computation according to the first embodiment;

FIG. 9 is a diagram explaining extrapolation-by-factor ratio computation according to the first embodiment;

FIG. 10 is a diagram explaining paired data retrieval according to the first embodiment;

FIG. 11 is a diagram illustrating a total-number-of-pairs model according to the first embodiment;

FIG. 12 is a diagram explaining a centroidal error according to the first embodiment;

FIG. 13 is a diagram illustrating a centroidal error model according to the first embodiment;

FIG. 14 is a diagram explaining unevenness according to the first embodiment;

FIG. 15 is a diagram illustrating an unevenness model according to the first embodiment;

FIG. 16A is a diagram explaining an average reference power difference of a truck according to the first embodiment;

FIG. 16B is a diagram explaining an average reference power difference of an upper object according to the first embodiment;

FIG. 17 is a diagram illustrating an average reference power difference model according to the first embodiment;

FIG. 18A is a flowchart illustrating a target information derivation process according to the first embodiment;

FIG. 18B is a flowchart illustrating a subroutine of unnecessary target removal according to the first embodiment;

FIG. 19 is a diagram explaining discrimination between a truck and an upper object according to the first embodiment;

FIG. 20A is a diagram illustrating a relationship between an angle power and a distance of a bus;

FIG. 20B is a diagram illustrating a relationship between an angle power and a distance of an upper object;

FIG. 21 is a diagram explaining average convex Null power computation according to a second embodiment;

FIG. 22 is a flowchart illustrating a subroutine of unnecessary target removal according to the second embodiment;

FIG. 23 is a schematic diagram illustrating the outline of target detection performed by a radar device according to a third embodiment;

FIG. 24 is a diagram illustrating the configuration of the radar device according to the third embodiment;

FIG. 25 is a diagram illustrating a relationship between a newly detected angle power and a distance;

FIG. 26 is a diagram illustrating a relationship between an angle power (instantaneous value) and a distance;

FIG. 27 is a diagram explaining the change in angle powers of a stationary vehicle and a lower object in a relationship between the change in an angle power and a distance in consideration of multipath;

FIG. 28 is a diagram explaining angle-power change amount computation in an angle-power difference distribution according to the third embodiment;

FIG. 29 is a diagram explaining the change in a variation of angle power of a stationary vehicle and a lower object in a relationship between the change in an angle power and a distance in consideration of multipath;

FIG. 30A is a diagram explaining stationary vehicle determination according to the third embodiment;

FIG. 30B is a diagram explaining lower object determination according to the third embodiment;

FIG. 31 is a flowchart illustrating a subroutine of unnecessary target removal according to the third embodiment; and

FIG. 32 is a diagram illustrating a mutually complementary relationship of discrimination between a stationary vehicle and a lower object according to the third embodiment.

### DESCRIPTION OF EMBODIMENTS

Hereinafter, a radar device and a control method of the radar device according to embodiments of the present application will be explained with reference to the accompanying drawings. The present application is not limited to the embodiments described below. Moreover, the embodiments described below are described with a central focus on the configuration and process related to the disclosed technology, and thus the explanations for the other configuration and process are omitted. The embodiments and alternative example may be appropriately combined within a scope in which they do not contradict each other. In the embodiments, the same components and steps have the same reference numbers, and explanations for the components and steps described already are omitted.

### First Embodiment

Outline of Target Detection by Radar Device according to First Embodiment. According to the first embodiment, even if a vehicle to be detected by a radar device is a large-sized vehicle such as a truck and a trailer in which a plurality of specular points of radar transmission waves (beams) are located on the back surface and lower surface of a vehicle body, the radar device detects the target from a comparatively long distance without performing erroneous discrimination that the large-sized vehicle is an upper object.

In other words, it is characteristic that reflected waves of beams reflected from a portion other than the rear end of a vehicle body have many peaks in a large-sized vehicle such as a truck of which the diameter of a tire is large. The reason is because the radar device detects beams returned by the reflection from the lower part of the vehicle body after the beams irradiated from the radar device enter below the vehicle body.

Therefore, in the first embodiment, it is assumed that a target of the rear end of the vehicle body is set as a reference target. Discrimination between a vehicle and an upper object is performed by using a Naive Bayes filter from a tendency of the number of targets, a positional relationship, and an angle power detected within a predetermined range within its own lane from the reference target, in order to enhance the reliability of the vehicle. In the following first embodiment, it is illustrated that a vehicle to be detected by a radar device is a truck. However, the vehicle may be a vehicle that has the same radar reflection characteristics as those of the truck.

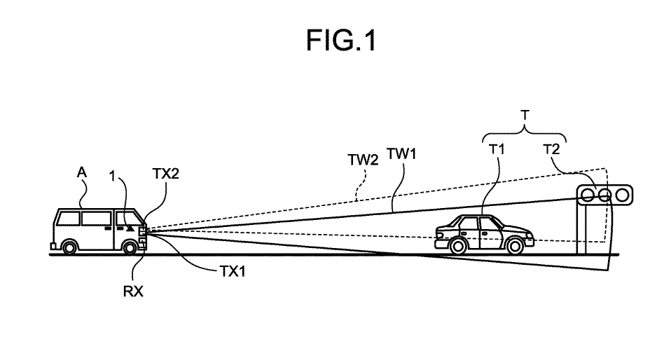

FIG. 1 is a schematic diagram illustrating the outline of target detection performed by a radar device 1 according to the first embodiment. The radar device 1 according to the first embodiment is provided in the front side, such as the front grille, of an own vehicle A, for example, and detects a target T (targets T1 and T2) existing in the traveling direction of the own vehicle A. The target T includes a moving target and a stationary target. The target T1 illustrated in FIG. 1 is a leading vehicle that moves along the traveling direction of the own vehicle A, for example, or is a stationary object (including stationary vehicle) that remains stationary. Moreover, the target T2 illustrated in FIG. 1 is an upper object, other than a vehicle, which upwardly remains stationary in the traveling direction of the own vehicle A, for example. For example, the upper object is a traffic light, an overpass, a traffic sign, a guide sign, etc.

In order to assure performance even if a vertical axis of a radar is inclined due to a load or a suspension of the own vehicle A, the radar device 1 is a scanning radar that alternately transmits a downward transmission wave TW1 and an upward transmission wave TW2 every 5 msec, for example, as illustrated in FIG. 1. The downward transmission wave TW1 is transmitted from a downward transmitting unit TX1 of the radar device 1 toward the lower side of the traveling direction of the own vehicle A. The upward transmission wave TW2 is transmitted from an upward transmitting unit TX2 of the radar device 1 toward the upper side of the traveling direction of the own vehicle A. The downward transmitting unit TX1 and the upward transmitting unit TX2 are antennas, for example.

As illustrated in FIG. 1, by overlapping a part of a scanning range by the downward transmission wave TW1 and the upward transmission wave TW2 in a vertical direction for the own vehicle A, the radar device 1 detects the target T within a wider range of the vertical direction than that of only one of the downward transmission wave TW1 and the upward transmission wave TW2. The radar device 1 receives, by a receiving unit RX, reflected waves obtained by reflecting the downward transmission wave TW1 and the upward transmission wave TW2 on the target T so as to detect the target T.

It is considered that the radar device 1 includes two transmitting units that respectively transmit the downward transmission wave TW1 and the upward transmission wave TW2 to alternately transmit the downward transmission wave TW1 and the upward transmission wave TW2. However, the present embodiment is not limited to this. In other words, the radar device 1 may include one transmitting unit to transmit a transmission wave in one direction.

Configuration of Radar Device According to First Embodiment

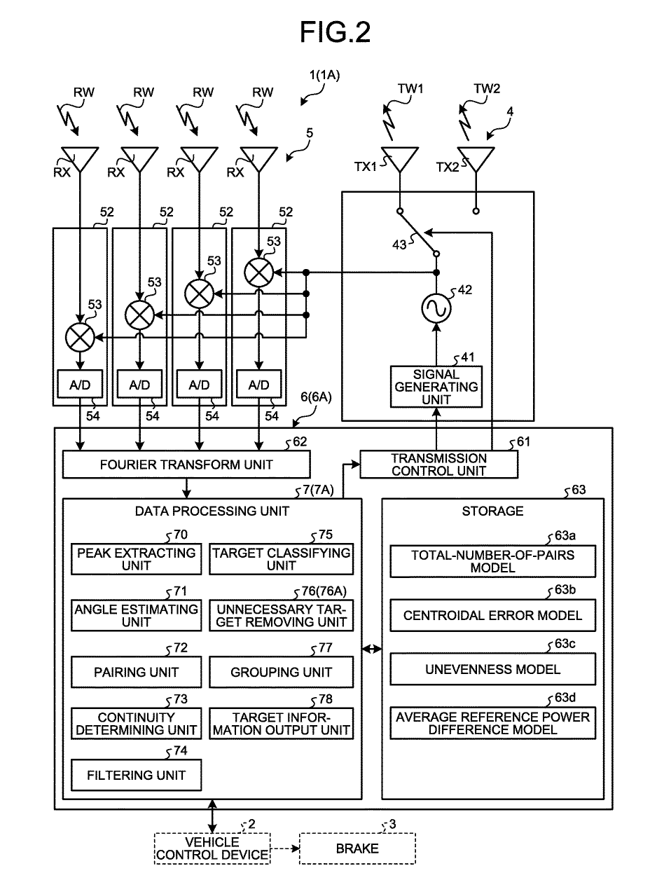

FIG. 2 is a diagram illustrating the configuration of the radar device 1 according to the first embodiment. The radar device 1 according to the first embodiment detects the target T existing in the vicinity of the own vehicle A by using FM-CW (Frequency Modulated-Continuous Wave) that is a continuous wave by a frequency modulation among various methods of a millimeter-wave radar, for example.

As illustrated in FIG. 2, the radar device 1 is connected to a vehicle control device 2. The vehicle control device 2 is connected to a brake 3 etc. For example, when a reception distance of a reflected wave, which is obtained by reflecting a transmission wave irradiated by the radar device 1 on the target T1, until the reflected wave is received by a receiving antenna of the radar device 1 becomes not more than a predetermined distance and thus there is danger that the own vehicle A collides with the target T1, the vehicle control device 2 controls the brake 3, a throttle, a gear, etc. and regulates the behavior of the own vehicle A to avoid the collision of the own vehicle A with the target T1. As an example of a system that performs such a vehicle control, there is an ACC (Adaptive Cruise Control) system, for example.

A reception distance of a reflected wave obtained by reflecting a transmission wave irradiated by the radar device 1 on the target T1 until the reflected wave is received by the receiving antenna of the radar device 1 is referred to as “longitudinal distance”, and a distance of the target T in the crosswise direction (vehicle-width direction) of the own vehicle A is referred to as “transverse distance”. The crosswise direction of the own vehicle A is a direction of a lane width on a road on which the own vehicle A travels. Assuming that the center position of the own vehicle A is an original point, a “transverse distance” is expressed with positive and negative values at the respective right and left sides of the own vehicle A.

As illustrated in FIG. 2, the radar device 1 includes a transmitting unit 4, a receiving unit 5, and a signal processing unit 6.

The transmitting unit 4 includes a signal generating unit 41, an oscillator 42, a switch 43, the downward transmitting unit TX1, and the upward transmitting unit TX2. The signal generating unit 41 generates a modulating signal whose voltage is changed in the shape of a triangular wave, and supplies the modulating signal to the oscillator 42. The oscillator 42 performs a frequency modulation on a continuous-wave signal on the basis of the modulating signal generated from the signal generating unit 41, generates a transmitted signal whose frequency is changed in accordance with the passage of time, and outputs the transmitted signal to the downward transmitting unit TX1 and the upward transmitting unit TX2.

The switch 43 connects one of the downward transmitting unit TX1 and the upward transmitting unit TX2 with the oscillator 42. The switch 43 operates by the control of a transmission control unit 61 to be described later at a predetermined timing (for example, every five milliseconds), and switches between the downward transmitting unit TX1 and the upward transmitting unit TX2 to be connected with the oscillator 42. In other words, the switch 43 performs switching in order of . . . →the downward transmitting unit TX1→the upward transmitting unit TX2→the downward transmitting unit TX1→the upward transmitting unit TX2→ . . . , for example, in such a manner that one selected by the switching is connected with the oscillator 42.

The downward transmitting unit TX1 and the upward transmitting unit TX2 respectively transmits the downward transmission wave TW1 and the upward transmission wave TW2 to the outside of the own vehicle A on the basis of the transmitted signal. Hereinafter, the downward transmitting unit TX1 and the upward transmitting unit TX2 may be collectively referred to as a “transmitting unit TX”. Although the one downward transmitting unit TX1 and the one upward transmitting unit TX2 are illustrated in FIG. 2, the number of transmitting units can be changed appropriately. The transmitting unit TX is composed of a plurality of antennas, and outputs the downward transmission wave TW1 and the upward transmission wave TW2 to respective different directions via the plurality of antennas to cover a scanning range. Hereinafter, the downward transmission wave TW1 and the upward transmission wave TW2 may be collectively referred to as a “transmission wave TW”.

The downward transmitting unit TX1 and the upward transmitting unit TX2 are connected to the oscillator 42 via the switch 43. For that reason, one of the downward transmission wave TW1 and the upward transmission wave TW2 is output from one transmitting unit in the transmitting unit TX depending on the switching operation of the switch 43. Moreover, the transmission wave TW to be output is sequentially switched by the switching operation of the switch 43.

The receiving unit 5 includes receiving units RX, which are four antennas forming an array antenna, and separate receiving units 52 that are respectively connected to the receiving units RX. Although the four receiving units RX are illustrated in FIG. 2, the number of receiving units can be changed appropriately. The receiving units RX receive reflected waves RW from the target T. Each of the separate receiving units 52 processes the reflected wave RW received via the corresponding receiving unit RX.

Each of the separate receiving units 52 includes a mixer 53 and an A/D (analog/digital) converter 54. A received signal obtained from the reflected wave RW received by the receiving unit RX is sent to the mixer 53. Moreover, a corresponding amplifier may be arranged between the receiving unit RX and the mixer 53.

The transmitted signal distributed from the oscillator 42 of the transmitting unit 4 is input into the mixer 53, and the transmitted signal and the received signal are mixed in the mixer 53. As a result, there is generated a beat signal indicating a beat frequency that is a difference frequency between the frequency of the transmitted signal and the frequency of the received signal. The beat signal generated from the mixer 53 is converted into a digital signal in the A/D converter 54 and then is output to the signal processing unit 6.

The signal processing unit 6 is a microcomputer that includes a central processing unit (CPU), a storage 63, etc., and controls the whole of the radar device 1. The signal processing unit 6 causes the storage 63 to store various types of data to be calculated, information on a target detected by a data processing unit 7, and the like. The storage 63 stores therein a total-number-of-pairs model 63a, a centroidal error model 63b, an unevenness model 63c, and an average reference power difference model 63d, which are described below. The storage 63 can employ an erasable programmable read-only memory (EPROM), a flash memory, etc., for example. However, the present embodiment is not limited to this.

The signal processing unit 6 includes the transmission control unit 61, a Fourier transform unit 62, and the data processing unit 7 as functions to be realized by a microcomputer in a software-based manner. The transmission control unit 61 controls the signal generating unit 41 of the transmitting unit 4 and also controls the switching of the switch 43. The data processing unit 7 includes a peak extracting unit 70, an angle estimating unit 71, a pairing unit 72, a continuity determining unit 73, a filtering unit 74, a target classifying unit 75, an unnecessary target removing unit 76, a grouping unit 77, and a target information output unit 78.

The Fourier transform unit 62 performs fast Fourier transform (FFT) with respect to the beat signal output from each of the plurality of separate receiving units 52. As a result, the Fourier transform unit 62 converts the beat signals according to the received signals of the plurality of receiving units RX into a frequency spectrum that is frequency-domain data. The frequency spectrum generated from the Fourier transform unit 62 is output to the data processing unit 7.

The peak extracting unit 70 extracts peaks, which exceed a predetermined signal level in the frequency spectrum generated from the Fourier transform unit 62, in up and down zones in which the frequency of the transmitted signal rises and falls respectively.

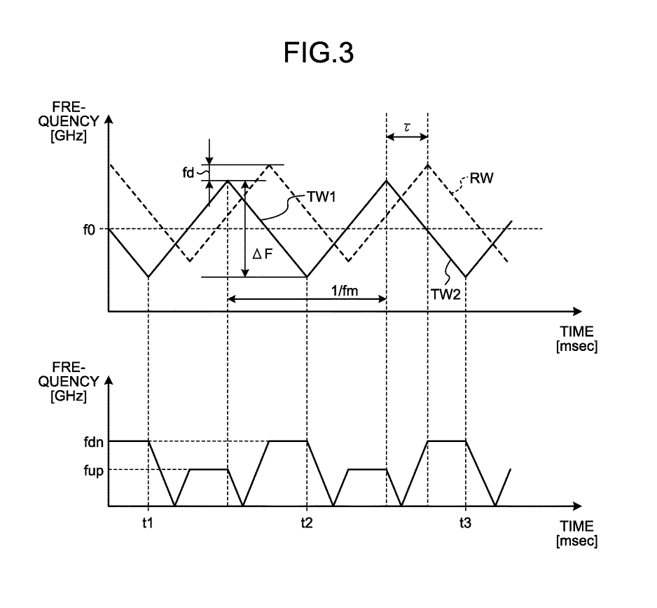

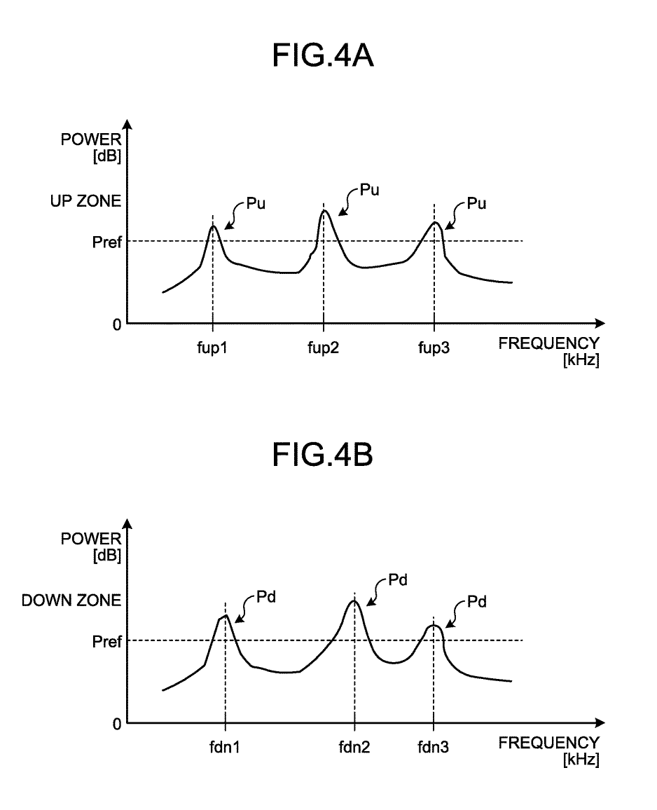

Herein, the process of the peak extracting unit 70 will be explained with reference to FIGS. 3, 4A, and 4B. FIG. 3 is a diagram illustrating a relationship between a transmission wave and a reflected wave and a beat signal. FIG. 4A is a diagram explaining peak extraction in an up zone. FIG. 4B is a diagram explaining peak extraction in a down zone. To simplify the explanation, the reflected wave RW illustrated in FIG. 3 is considered as an ideal reflected wave from the one target T. In FIG. 3, the transmission wave TW is illustrated with a solid line and the reflected wave RW is illustrated with a dotted line.

In an upper-side drawing of FIG. 3, its vertical axis indicates a frequency [GHz] and its horizontal axis indicates a time [msec]. In FIG. 3, it is assumed that the downward transmission wave TW1 is output in a zone of timings t1 to t2 and the upward transmission wave TW2 is output in a zone of timings t2 to t3.

As illustrated in FIG. 3, the downward transmission wave TW1 and the upward transmission wave TW2 are a continuous wave whose frequency goes up and down with a predetermined period around a predetermined frequency, and the frequency is linearly changed with respect to a time. Herein, it is assumed that the center frequency of the downward transmission wave TW1 and the upward transmission wave TW2 is f0, the displacement range of the frequency is ΔF, and the inverse number of one period in which the frequency goes up and down is fm.

Because the reflected wave RW is a wave obtained by reflecting the downward transmission wave TW1 and the upward transmission wave TW2 on the target T, the reflected wave RW is a continuous wave whose frequency goes up and down with a predetermined period around a predetermined frequency, similarly to the downward transmission wave TW1 and the upward transmission wave TW2. Herein, the reflected wave RW has a delay with respect to the downward transmission wave TW1 etc. A delay time τ is proportional to a longitudinal distance from the own vehicle A to the target T.

The reflected wave RW has a frequency deviation of a frequency fd with respect to the transmission wave TW due to the Doppler effect caused by a relative velocity of the target T to the own vehicle A.

As described above, the reflected wave RW has a delay time according to a longitudinal distance and a frequency deviation according to a relative velocity, with respect to the downward transmission wave TW1 etc. For this reason, as illustrated in a lower-side drawing of FIG. 3, the beat frequency of the beat signal generated by the mixer 53 has different values in the up zone (hereinafter, may be called “UP”) in which the frequency of the transmitted signal rises and the down zone (hereinafter, may be called “DN”) in which the frequency falls.

The beat frequency is a difference frequency between a frequency of the downward transmission wave TW1 etc. and a frequency of the reflected wave RW. Hereinafter, it is assumed that a beat frequency in an up zone is fup and a beat frequency in a down zone is fdn. In the lower-side drawing of FIG. 3, its vertical axis indicates a frequency [kHz] and its horizontal axis indicates a time [msec].

Next, as illustrated in FIGS. 4A and 4B, waveforms in frequency domains of the beat frequency fup in the up zone and the beat frequency fdn in the down zone are obtained after the Fourier transform in the Fourier transform unit 62. In FIGS. 4A and 4B, its vertical axis indicates a power [dB] of a signal and its horizontal axis indicates a frequency [KHz].

From the waveforms illustrated in FIGS. 4A and 4B, the peak extracting unit 70 extracts peaks Pu and peaks Pd that exceed a predetermined signal power Pref. Moreover, it is assumed that the peak extracting unit 70 extracts peaks Pu and Pd with respect to each of the downward transmission wave TW1 and the upward transmission wave TW2 illustrated in FIG. 3. The predetermined signal power Pref may be constant or variable. Moreover, the predetermined signal power Pref may have different values that are set for the respective up and down zones.

The frequency spectrum in the up zone illustrated in FIG. 4A has the peaks Pu respectively located at the positions of three frequencies fup1, fup2, and fup3. Moreover, the frequency spectrum in the down zone illustrated in FIG. 4B has the peaks Pd respectively located at the positions of three frequencies fdn1, fdn2, and fdn3. Although three peaks Pu and three peaks Pd are illustrated in FIGS. 4A and 4B, one or more peaks Pu and one or more peaks Pd can be generated. Hereinafter, a frequency may be referred to as “bin” as another unit. One bin is equivalent to about 467 Hz.

If a relative velocity is not considered, a frequency at a position at which a peak appears in the frequency spectrum corresponds to a longitudinal distance of a target. One bin is equivalent to about 0.36 m as a longitudinal distance. When looking at the frequency spectrum in the up zone, for example, a target exists at a position of a longitudinal distance corresponding to the frequency fup of the peak Pu. For this reason, the peak extracting unit 70 extracts frequencies that are indicated by the peaks Pu and Pd whose powers exceed the predetermined signal power Pref, with respect to both frequency spectra of the up zone and down zone. Hereinafter, a frequency to be extracted as described above is referred to as a “peak frequency”.

The frequency spectra of the up zone and down zone as illustrated in FIGS. 4A and 4B are obtained from a received signal received by the one receiving unit RX. Therefore, the Fourier transform unit 62 derives frequency spectra of the up zone and down zone from each of the received signals received by the four receiving units RX.

Because the four receiving units RX receive the reflected waves RW from the same target T, the frequency spectra of the four receiving units RX have the same extracted peak frequencies therebetween. Herein, because the positions of the four receiving units RX are different from one another, the phases of the reflected waves RW are different between the receiving units RX. For this reason, phase informations of received signals that have the same bin are different between the receiving units RX. Moreover, when the plurality of targets T exist at different angles of the same bin, a signal of one peak frequency in the frequency spectrum includes information on the plurality of targets T.

The angle estimating unit 71 derives information on the plurality of targets T located at the same bin from one peak-frequency signal for each of the up zone and down zone by using an azimuth calculation process, and estimates the angles of the plurality of targets T. The targets T located at the same bin are targets that have substantially the same longitudinal distance. The angle estimating unit 71 gives attention to the received signals of the same bin in all the frequency spectra of the four receiving units RX, and estimates the angles of the targets T on the basis of phase information of the received signals.

A technique for estimating the angle of the target T as described above employs a well-known angle estimation method such as ESPRIT (Estimation of Signal Parameters via Rotational Invariance Techniques), MUSIC (Multiple Signal Classification), and PRISM (Panchromatic Remote-sensing Instrument for Stereo Mapping). As a result, the angle estimating unit 71 computes a plurality of peak angles and powers of signals of the plurality of angles from a one-frequency signal.

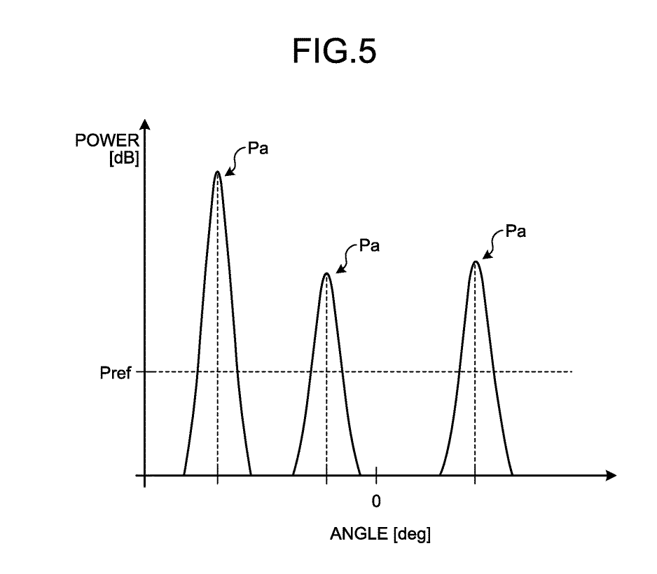

FIG. 5 is a diagram conceptually illustrating an angle estimated by an azimuth calculation process as an angle spectrum. In FIG. 5, its vertical axis indicates a power [dB] of a signal and its horizontal axis indicates an angle [deg]. In the angle spectrum, angles estimated by the azimuth calculation process are expressed with peaks Pa that exceed the predetermined signal power Pref. Hereinafter, an angle estimated by the azimuth calculation process is called a “peak angle”. A plurality of peak angles simultaneously derived from a one-peak-frequency signal as described above indicates the angles of the plurality of targets T located at the same bin.

The angle estimating unit 71 performs the derivation of peak angles as described above with respect to all peak frequencies in the frequency spectra of the up zone and down zone.

By the above process, the peak extracting unit 70 and the angle estimating unit 71 derive peak data corresponding to each of the plurality of targets T that exists in front of the own vehicle A in each of the up zone and down zone. Peak data includes parameters such as a peak frequency, a peak angle, a signal power (hereinafter, called “angle power”) of a peak angle described above.

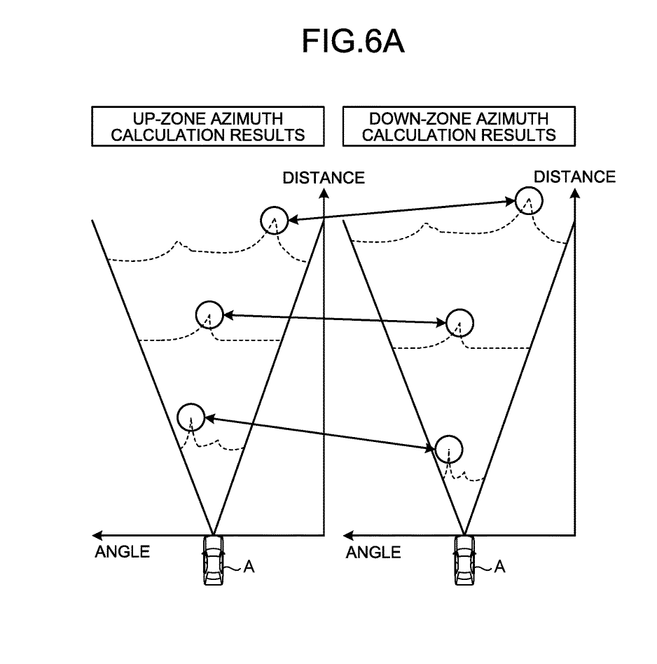

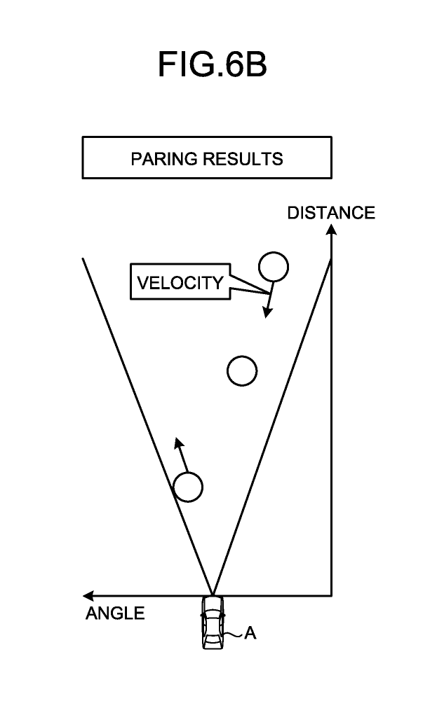

The pairing unit 72 performs pairing for associating the peaks Pu in the up zone with the peaks Pd in the down zone, on the basis of a degree of coincidence between a peak angle and an angle power in the up zone and a peak angle and an angle power in the down zone computed by the angle estimating unit 71. FIG. 6A is a diagram explaining pairing based on an azimuth angle and an angle power of each of the up zone and down zone. FIG. 6B is a diagram explaining a pairing result.

As illustrated in FIG. 6A, the pairing unit 72 pairs peaks of which a peak angle and an angle power are within a predetermined range, among azimuth calculation results of peaks of each of the UP and DN. In other words, the pairing unit 72 computes a Mahalanobis distance by using the peak angle and angle power of the frequency peak of each of the UP and DN, for example. The computation of the Mahalanobis distance employs a well-known art. The pairing unit 72 associates two peaks, whose Mahalanobis distances are the minimum value, of the UP and DN with each other.

As described above, the pairing unit 72 associates peaks related to the same target T with each other. As a result, the pairing unit 72 derives target data related to each of the plurality of targets T that exists in front of the own vehicle A. Because the target data is obtained by associating two peaks, it is referred to as “paired data”.

Next, as illustrated in FIG. 6B, the pairing unit 72 computes a relative velocity and a distance of each of the targets T with respect to the own vehicle A from the paired peaks of the UP and DN. For example, the pairing unit 72 can derive parameters (longitudinal distance, transverse distance, relative velocity) of target data by using two peak data of the up zone and down zone that function as the source of the target data (paired data). The radar device 1 detects the presence of the target T by performing pairing.

The processes performed by the peak extracting unit 70, the angle estimating unit 71, and the pairing unit 72 as described above are performed each time the reflected wave RW is received every beam irradiation (every scanning) that is alternately perform by the downward transmitting unit TX1 and the upward transmitting unit TX2, so as to derive instantaneous values of the parameters (longitudinal distance, transverse distance, relative velocity) of the target data.

The continuity determining unit 73 determines temporal continuity between target data derived by the past process and target data derived by the recent process. In other words, the continuity determining unit 73 determines whether the target data derived by the past process and the target data derived by the recent process are the same target. For example, the past process is the previous target data derivation process, and the recent process is the present target data derivation process. Specifically, the continuity determining unit 73 predicts a position of the present target data on the basis of the target data derived by the previous target data derivation process, and determines the nearest target data within a predetermined range of the predicted position derived by the present target data derivation process as target data that has continuity with the target data derived by the past process.

When target data that has continuity with the target data derived by the past process is not derived in the recent process, namely, when it is determined that there is not the continuity of the target data derived by the past process, the continuity determining unit 73 performs an “extrapolation process” for virtually deriving target data that is not derived by the recent process on the basis of the parameters (longitudinal distance, transverse distance, relative velocity) of the target data derived by the past process.

Extrapolation data derived by the extrapolation process is treated as target data derived by the recent process. If the extrapolation process is continuously performed on certain target data by multiple times or is performed at a comparatively high frequency, it is considered that the target is lost and then the target data is deleted from a predetermined storage area of the storage 63. Specifically, parameter information of a target number indicating the target is deleted, and a value (value indicating deletion flag OFF) indicating that the parameter has been deleted is set onto the target number. The target number is an index of identifying each target data, and different numbers are given to target data.

The filtering unit 74 smooths the parameters (longitudinal distance, transverse distance, relative velocity) of the two target data derived by the past process and recent process in a time-axial direction so as to derive target data. The target data after a filtering process as described above is referred to as “internal filter data” with respect to paired data that indicates an instantaneous value.

The target classifying unit 75 classifies targets into a leading vehicle, a stationary object (including stationary vehicle), and an oncoming vehicle on the basis of relative velocities. For example, the target classifying unit 75 classifies as a “leading vehicle” a target that has the same direction as that of the velocity of the own vehicle A and whose relative velocity is larger than the size of the velocity of the own vehicle A. Moreover, the target classifying unit 75 classifies as a “stationary object” a target that has a substantially-inverse-direction relative velocity with respect to the velocity of the own vehicle A. Moreover, the target classifying unit 75 classifies as an “oncoming vehicle” a target that has an inverse direction to that of the velocity of the own vehicle A and whose relative velocity is larger than the size of the velocity of the own vehicle A. Moreover, a “leading vehicle” may be a target that has the same direction as that of the velocity of the own vehicle A and whose relative velocity is smaller than the size of the velocity. Moreover, an “oncoming vehicle” may be a target that has an inverse direction to that of the velocity of the own vehicle A and whose relative velocity is smaller than the size of the velocity.

The unnecessary target removing unit 76 determines, among targets, an upper object, a lower object, rain, receiving wave ghosting, etc. as an unnecessary target, and excludes the determined target from an output target. A process for determining an upper object among unnecessary targets will be explained in detail later.

The grouping unit 77 groups a plurality of target data to merge them into one as target data of the same object. For example, the grouping unit 77 merges target data, of which the detected position and velocity are close to each other within the predetermined range, into one as the target data of the same object to output the target data as one output. As a result, the number of outputs of the target data is reduced.

The target information output unit 78 selects the predetermined-number (for example, ten) target data from the plurality of target data derived or derived by extrapolation as target data to be output, and outputs the selected target data to the vehicle control device 2. The target information output unit 78 preferentially selects target data that exist within its own lane and are related to a target closer to the own vehicle A, on the basis of the longitudinal distance and transverse distance of the target data. Herein, “its own lane” is a traveling lane obtained by assuming that, when the own vehicle A is traveling at the substantial center of a traffic lane, widths from the center to both ends of the traffic lane are approximately 1.8 meters. The width that defines “its own lane” can be changed appropriately.

The target data derived by the above target data derivation process is stored in the predetermined storage area of the storage 63 as a parameter corresponding to a target number indicative of each target data, and is used as the target data derived by the past process in the next target data derivation process.

In other words, the target data derived by the past target data derivation process is saved as a “history”. For example, the peak extracting unit 70 predicts a “peak frequency” having temporal continuity with the “history” with reference to the “peak frequency” stored as the “history” in the predetermined storage area of the storage 63, and predicts a frequency within ±3 bin of the predicted “peak frequency”, for example. As a result, the radar device 1 can quickly select a “peak frequency” corresponding to a target that needs to be preferentially output to the vehicle control device 2. A “peak frequency” of the predicted present target data is called “prediction bin”.

Discrimination Process of Truck and Upper Object According to First Embodiment

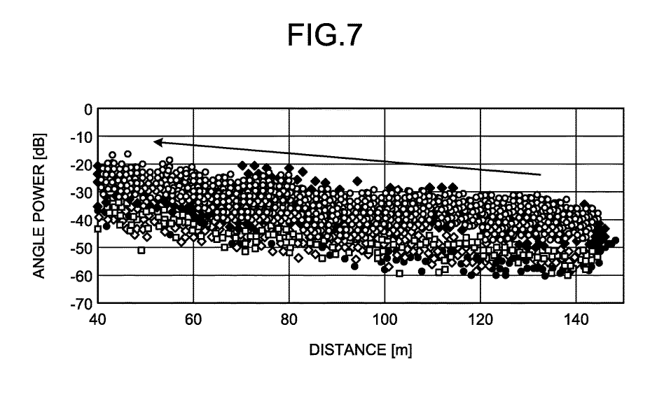

Hereinafter, the details of a discrimination process of a truck and upper object performed by the unnecessary target removing unit 76 according to the first embodiment will be explained in the order of STEP 1 to STEP 4 with reference to FIGS. 7 to 16.

Step 1: Reference Target Extraction

The unnecessary target removing unit 76 extracts a reference target equivalent to the rear end of a stationary vehicle (for example, truck) on the basis of determination results of whether conditions of the following (a1) to (a6) are satisfied.

(a1): A target object is a stationary object.

(a2): A tunnel, a truss bridge, etc. are not a target object under a bad environment for the radar device 1.

(a3): A tendency of a distance and an angle power is rising without damping.

(a4): It is a target object closest to its own lane and the own vehicle A.

(a5): The change of a specular point is small when it approaches linearly.

(a6): Reflection as the whole of a target object is stable.

(a1) is determined by the target classifying unit 75 on the basis of a relative velocity of a target. (a2) is determined based on the fact that the number of targets detected by the angle estimating unit 71 does not exist within its own lane by a predetermined number or more. For example, in case of target objects, such as a tunnel and a truss bridge, under a bad environment for the radar device 1, the number of targets detected by the angle estimating unit 71 is based on the fact that many targets not less than a predetermined number exist within its own lane.

As illustrated in FIG. 7, (a3) is based on the fact that angle powers of a truck tend to rise without damping as a distance with the own vehicle A becomes nearer. FIG. 7 is a diagram illustrating a relationship between an angle power and a distance of a truck.

(a4) is based on the fact that the rear end of the truck is a target object that exists closest to its own lane and the own vehicle A.

(a5) can be determined on the basis of an “average lateral position movement amount” computed based on the following Equations (1-6) to (1-10) under conditions of the following Equations (1-1) to (1-5), for example. For example, a target object such as an overpass having a width, a signboard with legs, etc. tend to cause specular points to largely move as its distance becomes nearer. Herein, the size of a specular-point movement of the target object is expressed with an averaged lateral position (average lateral position movement amount) in a quantitative way. Dividing (namely, averaging) a sum of lateral position areas by a distance by which the own vehicle has advanced in a longitudinal direction is to absorb a perspective impact of a first-detected distance. When the “average lateral position movement amount” is not more than a predetermined size, it is determined that the condition of (a5) is satisfied.

$$Condition \\ AND \{ \begin{matrix}Inside\_new flag ( 1 \text{-} 1 ) \\ Inside\_leading - vehicle flag ( 1 \text{-} 2 ) \\ Inside\_moving - object flag ( 1 \text{-} 3 ) \\ Curve ( 1 \text{-} 4 ) \\ Own - vehicle velocity ( 1 \text{-} 5 )\end{matrix} \qquad$$

Average lateral position movement amount computation process

Longitudinal position difference=Longitudinal position (previous time)−Longitudinal position (1-6)

Longitudinal position zone=Longitudinal position zone (previous time)+Longitudinal position difference (1-7)

Lateral position area=Longitudinal position difference×Lateral position(previous time) (1-8)

Sum of lateral position areas=Sum of lateral position areas(previous time)+Lateral position area (1-9)

Average lateral position movement amount=Sum of lateral position areas+Longitudinal position zone (1-10)

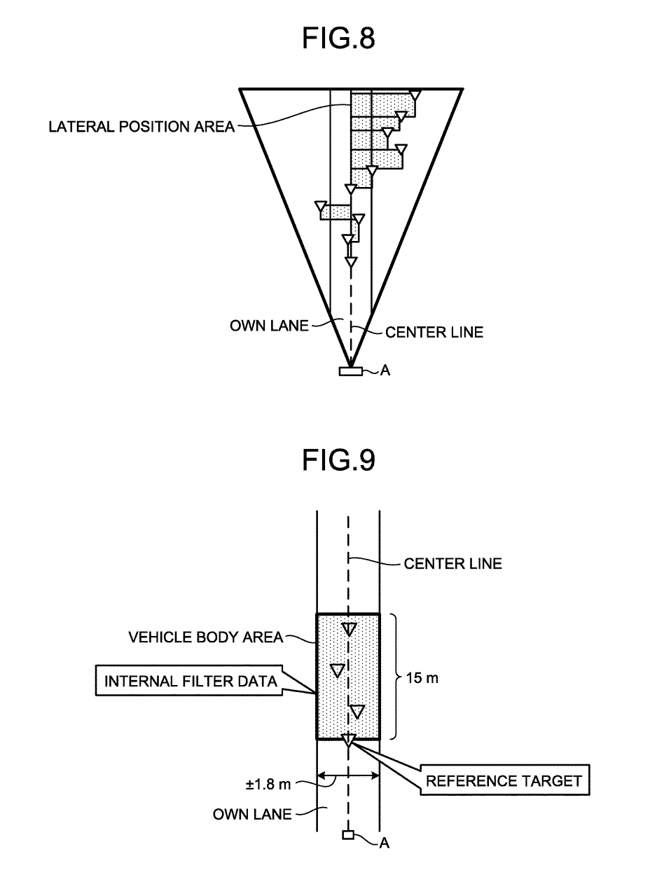

The Equations (1-1) to (1-10) will be explained with reference to FIG. 8. FIG. 8 is a diagram explaining average lateral position movement amount computation according to the first embodiment. In FIG. 8, the detection of targets indicated with “∇” by the radar device 1 in front of the own vehicle A that is traveling on its own lane is illustrated in chronological order, and the drawing means that a target is newly detected as it is closer to the own vehicle A.

The Equation (1-1) indicates that targets indicated with “∇” in FIG. 8 are not newly detected targets but are targets detected by the past process. The Equations (1-2) and (1-3) indicate that targets indicated with “∇” in FIG. 8 are not a leading vehicle but are a stationary object. “ABS(curve R[m])” in the Equation (1-4) indicates an absolute value of a curvature radius of its own lane, and this indicates that its own lane in FIG. 8 is not a sharp curve but is a substantially linear. The Equation (1-5) indicates that the own vehicle A in FIG. 8 is traveling.

The Equation (1-6) is a formula for computation for computing each distance (longitudinal position difference) along a center line between almost simultaneous targets indicated with “∇” in FIG. 8. The Equation (1-7) is a formula for computation for integrating longitudinal position differences computed by the Equation (1-6). The Equation (1-8) is a formula for computation for multiplying the longitudinal position difference computed by the Equation (1-6) by each distance (lateral position (previous time)) from the center line of each target indicated with “∇” in FIG. 8 to compute an area of each rectangle illustrated in FIG. 8. The Equation (1-9) is a formula for computation for integrating lateral position areas computed by the Equation (1-8). The Equation (1-10) is a formula for computation for dividing the sum of the lateral position areas computed by the Equation (1-9) by a longitudinal position zone computed by the Equation (1-7) to compute an average lateral position movement amount. By the process, a target whose average lateral position movement amount is not less than a predetermined value, namely, whose average lateral position movement amount is large comparatively is determined to be an upper object with a high possibility.

(a6) can be determined based on an “extrapolation-by-factor ratio” computed based on the following Equations (2-1) to (2-8), namely, an extrapolation ratio and each ratio according to a factor of extrapolation, for example. For example, although an upper object such as an overpass tends to cause the radar device to detect two or more paired data similarly to a truck, an extrapolation process is performed in many cases because reflection is instable. Herein, when it is considered as an upper object from the characteristics of extrapolation data, the upper object is excluded from the reference target. When an extrapolation ratio based on the following Equation (2-1) and all “extrapolation-by-factor ratios” based on the following Equations (2-2) to (2-8) become not more than a predetermined value, it is determined that the condition of (a6) is satisfied, and thus this target satisfies one of conditions under which it is determined as a reference target.

Extrapolation-by-factor ratio computation process

Whole extrapolation ratio=Number of extrapolation accumulations/Number of internal filter accumulations (2-1)

Without-history ratio=Number of without-history accumulations/Number of extrapolation accumulations (2-2)

Without-peak ratio=Number of without-peak accumulations/Number of extrapolation accumulations (2-3)

Without-angle ratio=Number of without-angle accumulations/Number of extrapolation accumulations (2-4)

Prediction-bin-deviance ratio=Number of prediction-bin-deviance accumulations/Number of extrapolation accumulations (2-5)

Mahalanobis-distance-NG ratio=Number of Mahalanobis-distance-NG accumulations/Number of extrapolation accumulations (2-6)

Without-pair ratio=Number of without-pair accumulations/Number of extrapolation accumulations (2-7)

Without-continuity ratio=Number of without-continuity accumulations/Number of extrapolation accumulations (2-8)

FIG. 9 is a diagram explaining extrapolation-by-factor ratio computation according to the first embodiment. The presence or absence of extrapolation is determined and factors are counted every type when extrapolation is present, with respect to all internal filter data located in an area from the reference target within its own lane to 15 [m] in the front direction, for example, illustrated in FIG. 9. The number of extrapolation accumulations and the number of accumulations of each count of each extrapolation type and counted by the continuity determining unit 73 that performs the extrapolation process, and are stored in the predetermined storage area of the storage 63, for example.

It is assumed that an area from the reference target within its own lane to 15 [m] in the front direction, for example, illustrated in FIG. 9 is a vehicle body (hereinafter, called “vehicle body area”) of the truck. Herein, 15 [m] can be changed appropriately. A ratio of each extrapolation factor type can be computed from the number of accumulations of each count up to the present scanning. The type of an extrapolation factor has seven kinds of “without-history”, “without-peak”, “without-angle”, “prediction-bin-deviance”, “Mahalanobis-distance-NG”, “without-pair”, and “without-continuity”, for example.

“Without-history” means that a “history” corresponding to a “peak frequency” presently extracted cannot be acquired or that there is not a “history”. “Without-peak” means that peak extraction by the peak extracting unit 70 cannot be performed from the frequency spectra generated by the Fourier transform unit 62. “Without-angle” means that peak extraction by the peak extracting unit 70 can be performed but angle estimation of a target by the angle estimating unit 71 cannot be performed.

“Prediction-bin-deviance” means that the actual position of the present target data is not within a predetermined range (for example, within ±3 bin) of a predicted position of the present target data predicted by the continuity determining unit 73.

“Mahalanobis-distance-NG” means that pairing by the pairing unit 72 cannot be performed because the minimum value of a Mahalanobis distance is not less than a predetermined value. “Without-pair” means that pairing by the pairing unit 72 cannot be performed due to a factor other than “without-history”, “without-peak”, “without-angle”, “prediction-bin-deviance”, and “Mahalanobis-distance-NG”.

“Without-continuity” means that pairing by the pairing unit 72 can be performed but the continuity determining unit 73 determines that they do not have temporal continuity with the target data derived by the recent process.

The Equation (2-1) is a formula for computation for computing a ratio of the number of accumulations of all extrapolation data to the number of accumulations of all internal filter data, regardless of an extrapolation type. The Equations (2-2) to (2-8) are formulas for computation for computing a ratio of each of the numbers of accumulations of the extrapolation data, whose factors are “without-history”, “without-peak”, “without-angle”, “prediction-bin-deviance”, “Mahalanobis-distance-NG”, “without-pair”, and “without-continuity”, with respect to the number of accumulations of internal filter data.

As described above, on the basis of the conditions of (a1) to (a6), when the target object is a stationary object (satisfaction of condition of (a1)) and is not a target object under a bad environment for the radar device 1 (satisfaction of condition of (a2)), a tendency of a distance and an angle power is rising without damping (satisfaction of condition of (a3)). Then, the target object comes closest to the inside of its own lane and the own vehicle A (satisfaction of condition of (a4)), and the change of a specular point is small when it approaches linearly (satisfaction of condition of (a5)). When reflection as the whole of the target object is stable (satisfaction of condition of (a6)), the target is set as a reference target equivalent to the rear end of the stationary vehicle (for example, truck). Moreover, when any of the conditions of (a1) to (a6) is not satisfied, the target may be an upper object, and thus is not set as a reference target.

Step 2: Paired Data Retrieval

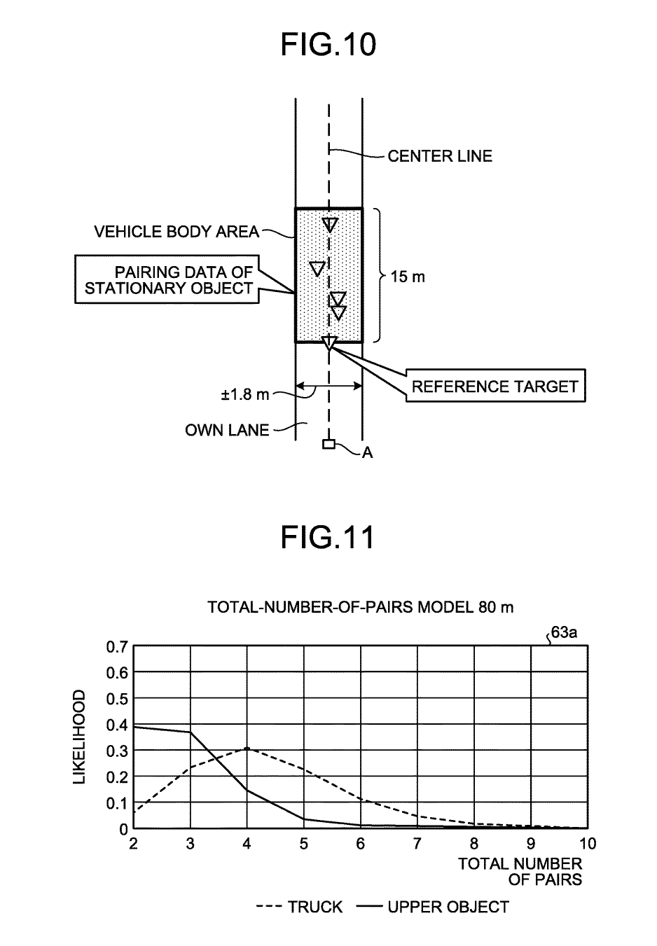

After extracting the reference target by using STEP 1, pairing data (instantaneous value before filtering) of the stationary object located in the “vehicle body area” illustrated in FIG. 10 is extracted. FIG. 10 is a diagram explaining paired data retrieval according to the first embodiment. The pairing data of the stationary object instead of internal filter data is extracted. The reason is that the number of samples can be secured and thus it is preferable to compute unevenness of Score in STEP 3 to be described later because the pairing data of the stationary object is an instantaneous value. Moreover, the pairing of the stationary object may be performed on data after filtering.

Step 3: Score Computation

Score is computed by using the following Equations (3-1) to (3-2) from the position and power relationship with the reference target and the number (total number of pairs) of paired data of the stationary object extracted in STEP 2. As indicated by the following Equation (3-1), Score is composed of four parameters (Score1 (total number of pairs), Score2 (centroidal error), Score3 (unevenness), and Score4 (average reference power difference)), and is accumulated every cycle. This accumulation every cycle is equivalent to Bayesian updating. When Score is not less than a threshold value, it is determined to be a stationary vehicle (truck) on the ground of high reliability. When it is less than the threshold value, it is determined to be an upper object on the ground of low reliability.

Score=Score1(Total number of pairs)+Score2(Centroidal error)+Score3(Unevenness)+Score4(Average reference power difference) (3-1)

Score n=log(Truck likelihood n/Upper-object likelihood n)=log(Truck likelihood n)−log(Upper-object likelihood n) (n=1,2,3,4) (3-2)

In the Equation (3-2), each Score of Score1 to Score4 is obtained by computing a logarithmic likelihood from a probability distribution model of each of a truck and upper object to compute logit. Because it turns out that distributions of parameters of the total number of pairs, a centroidal error, an unevenness, and an average reference power difference are changed depending on a distance with a target object, a probability distribution model used for Score computation uses a model in which the model is predefined or constructed every 10 m, for example, on the basis of measured data to perform linear interpolation on a part below 10 m.

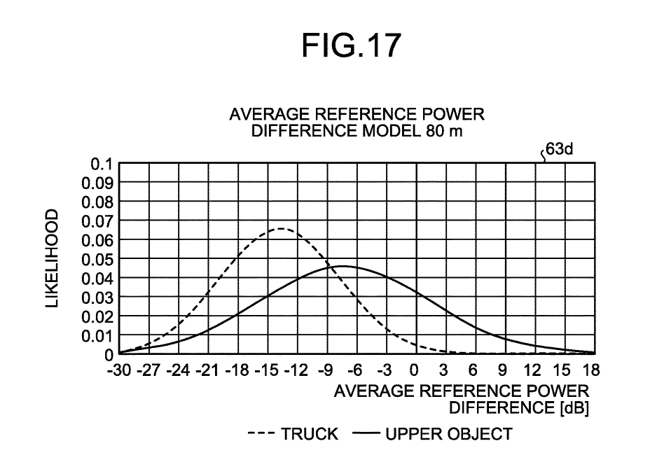

The probability distribution model used for Score computation includes the total-number-of-pairs model 63a, the centroidal error model 63b, the unevenness model 63c, and the average reference power difference model 63d, as described above with reference to FIG. 2. The details of the total-number-of-pairs model 63a will be described below with reference to FIG. 11. The details of the centroidal error model 63b will be described below with reference to FIG. 13. The details of the unevenness model 63c will be described below with reference to FIG. 15. The details of the average reference power difference model 63d will be described below with reference to FIG. 17.

Step 3-1: Score1 (Total Number of Pairs) Computation

One of representative parameters for discriminating between a truck and an upper object is the total number of pairs, namely, the total number of stationary-object pairing data located in the “vehicle body area”. In other words, this is based on the fact that the total number of pairs retrieved in STEP 2: Paired Data Retrieval described above is larger, namely, the plurality of stable pairing data (reflection peaks) are obtained more largely, and a likelihood that the target object is a truck is higher. Score1 (total number of pairs) is obtained by applying a statistical model to a parameter obtained by quantifying the total number of pairing data and performing likelihood computation.

Score1 (total number of pairs) is computed from the total-number-of-pairs model 63a illustrated in FIG. 11 and Equation (3-2). FIG. 11 is a diagram illustrating the total-number-of-pairs model according to the first embodiment. The total-number-of-pairs model 63a is a probability distribution model that indicates a relationship between the total number of pairs and a likelihood of each of a truck and upper object when its horizontal axis is the total number of pairs and its vertical axis is the likelihood. The probability distribution model of the truck illustrated in FIG. 11 is a model based on a normal distribution (Gaussian distribution) for example. Moreover, the probability distribution model of the upper object illustrated in FIG. 11 is a model based on a maximum likelihood estimation method and an experimental design method. In the case of the model of the truck, a model based on a normal distribution is set when the longitudinal distance of the truck is 70 m for example, and a model based on a gamma distribution is set when the longitudinal distance of the truck is 80 m for example. In other words, a technique for setting a model is changed depending on the longitudinal distance of the truck. As described above, in the total-number-of-pairs model 63a, a parameter characterizing a model is adjusted for each of the truck and upper object for the improvement of determination accuracy.

In FIG. 11, the total-number-of-pairs model when a distance from the own vehicle A to the reference target is 80 m is illustrated as the total-number-of-pairs model 63a. There is omitted the illustration of the total-number-of-pairs model of each distance per 10 m from 10 m to 80 m and up to about 150 m from the viewpoint of the distance from the own vehicle A to the reference target.

For example, it is considered that the total number of pairs computed in STEP 2 described above is “4”. In this case, referring to FIG. 11, when the total number of pairs of the horizontal axis is “4”, the likelihood of the truck of the vertical axis is about “0.31” and the likelihood of the upper object is about “0.15”. Therefore, assuming that n=1 in Equation (3-2), Score1 can be computed as Score1=log(truck likelihood 1)−log(upper-object likelihood 1)=log(0.31)−log(0.15).

Step 3-2: Score2 (Centroidal Error) Computation

An upper object that has two or more specular points cannot be sufficiently determined with only the total number of pairs of STEP 3-1. Therefore, a centroid obtained by quantifying a bias of a paired-data group is used for Score computation. In case of a truck, a trailer, etc., the positions of a centroid are different depending on the size of the vehicle body. In other words, a centroid is closer to this side (position close to reference target) if it is a smaller vehicle. A centriod is closer to the back (position distant from reference target) if it is a larger-sized vehicle. A ratio of a misaligned amount from a provisional centroid is computed as a centroidal error so as to be able to reflect the differences on Score. Score2 (centroidal error) is obtained by applying a statistical model on a parameter obtained by quantifying a positional relationship of pairing data and performing likelihood computation. A centroidal error can be computed on the basis of the following Equations (4-1) to (4-4).

$$\begin{matrix} Centroid = \frac{{\sum }_{i = 2}^{n} ( Pair\_distance i - Pair\_distance 1 )}{n - 1} \\ n \text{:} Total number of pairs & ( 4 \text{-} 1 ) \\ Length = Pair\_maximum distance - Pair\_minimum distance & ( 4 \text{-} 2 ) \\ Provisional centroid = ( Length ) / 2 & ( 4 \text{-} 3 ) \\ Centroidal error = ( Centroid - Provisional centroid ) / Provisional centroid & ( 4 \text{-} 4 )\end{matrix}$$

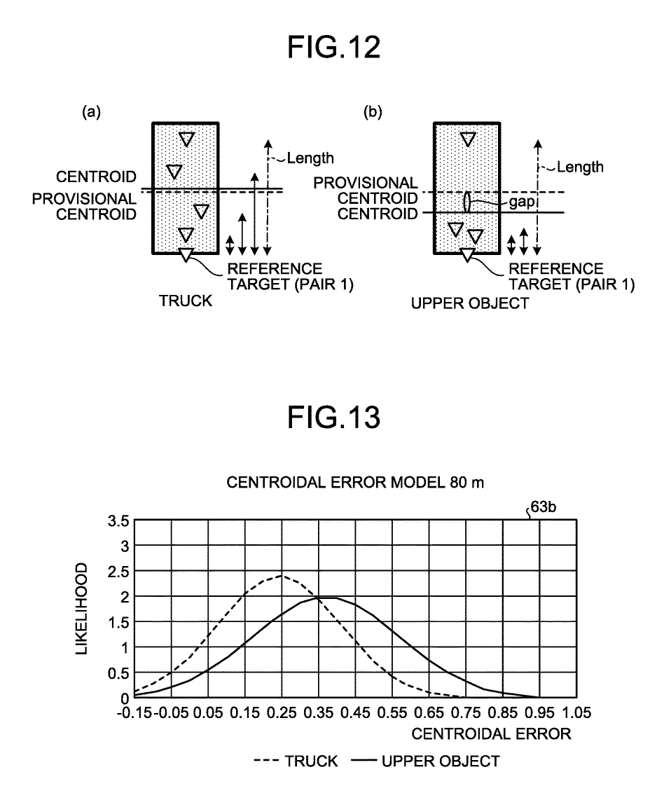

The computation of a centroidal error will be explained with reference to FIG. 12. FIG. 12 is a diagram explaining a centroidal error according to the first embodiment. Equation (4-1) is a formula for computation for computing a distance between pair 1 and each of pair i (i=2, . . . , n) of number i by using “pair_distancei−pair_distance1” to compute an average thereof when the reference target is pair 1 of number 1. A “centroid” is computed by Equation (4-1).

For example, when the reference target (pair 1) and four pairs (targets) are within the vehicle body area as illustrated in (a) of FIG. 12, a “centroid” is computed by averaging distances between the reference target (pair 1) and the four pairs (targets) on the basis of Equation (4-1). Then, among distances between the reference target (pair 1) and the four pairs (targets), the maximum distance is computed as “Length” on the basis of Equation (4-2). Then, a “provisional centroid” is computed by “Length-2” on the basis of Equation (4-3). Then, a “centroidal error” is computed from the “centroid” and “provisional centroid” computed in Equations (4-1) and (4-3) on the basis of Equation (4-4).

Similarly, for example, as illustrated in (b) of FIG. 12, when the reference target (pair 1) and three pairs (targets) are within the vehicle body area, a “centroid” is computed by averaging distances between the reference target (pair 1) and the three pairs (targets) on the basis of Equation (4-1). Then, among the distances between the reference target (pair 1) and the three pairs (targets), the maximum distance is computes as “Length” on the basis of Equation (4-2). Then, a “provisional centroid” is computed by “Length÷2” on the basis of Equation (4-3). Then, a “centroidal error” is computed from the “centroid” and “provisional centroid” computed in Equations (4-1) and (4-3) on the basis of Equation (4-4).

The “centroidal error” indicates a ratio of “deviance” from the “provisional centroid” of the “centroid”. As can be seen from (a) and (b) of FIG. 12, it turns out that an upper object has a “deviance” (“gap” in (b) of FIG. 12) larger than that of a truck.

Score2 (centroidal error) is computed from the centroidal error model 63b illustrated in FIG. 13 and Equation (3-2). FIG. 13 is a diagram illustrating a centroidal error model according to the first embodiment. The centroidal error model 63b is a probability distribution model that indicates a relationship between the centroidal error and likelihood of each of the truck and upper object when its horizontal axis is a centroidal error and its vertical axis is a likelihood. The probability distribution models of the truck and upper object illustrated in FIG. 13 are, for example, a model based on a normal distribution previously constructed by a maximum likelihood estimation method and an experimental design method. In the centroidal error model 63b, a parameter characterizing a model is adjusted for each of the truck and upper object for the improvement of determination accuracy.

In FIG. 13, a centroidal error model when the distance from the own vehicle A to the reference target is 80 m is illustrated as the centroidal error model 63b. There is omitted the illustration of a centroidal error model of each distance per 10 m from 10 m to 80 m and up to about 150 m from the viewpoint of the distance from the own vehicle A to the reference target.

For example, it is considered that the centroidal error computed by Equation (4-4) is “0.15”. In this case, referring to FIG. 13, when the centroidal error of the horizontal axis is “0.15”, the likelihood of the truck of the vertical axis is about “2.1” and the likelihood of the upper object is about “1.1”. Therefore, assuming that n=2 in Equation (3-2), Score2 can be computed as Score2=log(truck likelihood 2)−log(upper-object likelihood 2)=log(2.1)−log(1.1).

Step 3-3: Score3 (Unevenness) Computation

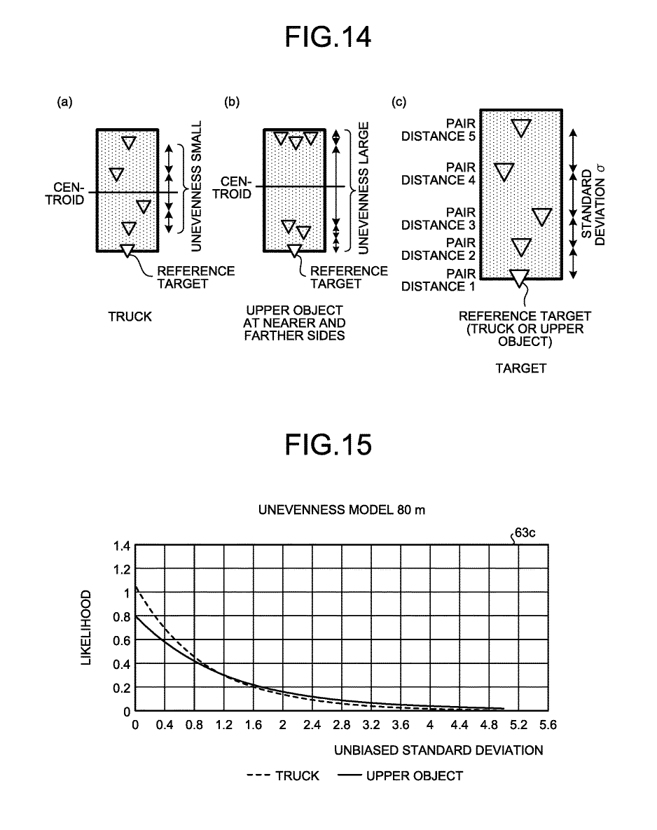

FIG. 14 is a diagram explaining unevenness according to the first embodiment. In the total number of pairs and the centroidal error, as illustrated in (a) of FIG. 14, for example, it can be determined that it is a truck when the positions of paired data are not biased. However, as illustrated in (b) of FIG. 14, the determination of the truck and upper object is difficult when the positions of paired data are biased at the reference-target side and the farthest side from the reference target. Therefore, evaluation is performed after quantifying unevenness of the extracted paired data. Moreover, the unevenness of paired data means that a position of a target detected from a certain object is changed for each processing timing, and is caused by the fact that spots of the certain object on which the transmission wave of the radar device is reflected are different depending on processing timings. This is easy to occur in case of an object that has a comparatively large size and a complicated shape.

In other words, Score3 (unevenness) is obtained by applying a statistical model on a parameter obtained by quantifying a positional relationship of pairing data to perform likelihood computation. As illustrated in (c) of FIG. 14, an unevenness is computed by computing an unbiased standard deviation V from a standard deviation a of a distance between paired data. The computation of the unbiased standard deviation V uses a well-known method. Discrimination between the truck and upper object performed by quantification of unevenness of paired data is based on the fact that the specular points of the truck are determined but the specular points of the upper object are uneven due to instability.

Score3 (unevenness) is computed from the unevenness model 63c illustrated in FIG. 15 and Equation (3-2). FIG. 15 is a diagram illustrating an unevenness model according to the first embodiment. The unevenness model 63c is a probability distribution model that indicates a relationship between an unbiased standard deviation and a likelihood of each of the truck and upper object when its horizontal axis is an unbiased standard deviation and its vertical axis is a likelihood. The probability distribution models of the truck and upper object illustrated in FIG. 15 are a model based on, for example, an exponential distribution previously constructed by a maximum likelihood estimation method and an experimental design method. In the unevenness model 63c, a parameter characterizing a model is adjusted for each of the truck and upper object for the improvement of determination accuracy.

In FIG. 15, an unevenness model when the distance from the own vehicle A to the reference target is 80 m is illustrated as the unevenness model 63c. There is omitted the illustration of an unevenness model of each distance per 10 m from 10 m to 80 m and up to about 150 m from the viewpoint of the distance from the own vehicle A to the reference target.

For example, it is considered that the unbiased standard deviation V is “0.4”. In this case, referring to FIG. 15, when the unbiased standard deviation of the horizontal axis is “0.4”, the likelihood of the truck of the vertical axis is about “0.7” and the likelihood of the upper object is about “0.58”. Therefore, assuming that n=3 in Equation (3-2), Score3 can be computed as Score3=log(truck likelihood 3)−log (upper-object likelihood 3)=log(0.7)−log(0.58).

Step 3-4: Score4 (Average Reference Power Difference) Computation

In the case of a truck, as compared to the rear-end reference target, paired data within the vehicle body area tends to damp a reflection level due to the influence of multipoint reflection and multipath. Therefore, a power difference between each paired data and the reference target is computed for all paired data, and the power difference is used for the computation of Score. Score4 (average reference power difference) is obtained by applying a statistical model on a parameter obtained by quantifying an angle power of pairing data to perform likelihood computation. In Score4 (average reference power difference), normalization (averaging) is performed as expressed by the following Equation (5) so that a power difference is not excessively computed due to the excess of the total number of pairs.

$$Average reference power difference = \frac{{\sum }_{i = 2}^{n} \{ \begin{matrix}Distance \text{-} {difference}_{i - 1} \times \\ ( Angle \text{-} {power}_{i} - Angle \text{-} {power}_{1} )\end{matrix} \}}{{\sum }_{i = 2}^{n} Distance \text{-} {difference}_{i - 1}} \qquad ( 5 )$$

The “distance-differenceᵢ₋₁” of Equation (5) indicates each distance of paired data for which distances from pair 1 within the vehicle body area are almost simultaneous when the reference target is pair 1 of number 1. For example, assuming that a pair closest to pair 1 within the vehicle body area is pair 2, a “distance−difference₁”=a distance between pair 2 and pair 1. Moreover, assuming that a pair secondly close to pair 1 within the vehicle body area is pair 3, for example, a “distance−difference₂=a distance between pair 3 and pair 2. The other “distance−differenceᵢ₋₁” is similar to the above.

The “angle-powerᵢ” of Equation (5) indicates the angle power of pair i assuming that a (i−1)-th (i=2, . . . , n) pair close to pair 1 within the vehicle body area is pair i. Moreover, the “angle-powerᵢ” of Equation (5) indicates the angle power of pair 1 within the vehicle body area. Therefore, the “angle-powerᵢ−angle-power₁” in Equation (5) is a difference between the angle power of pair i and the angle power of pair 1.

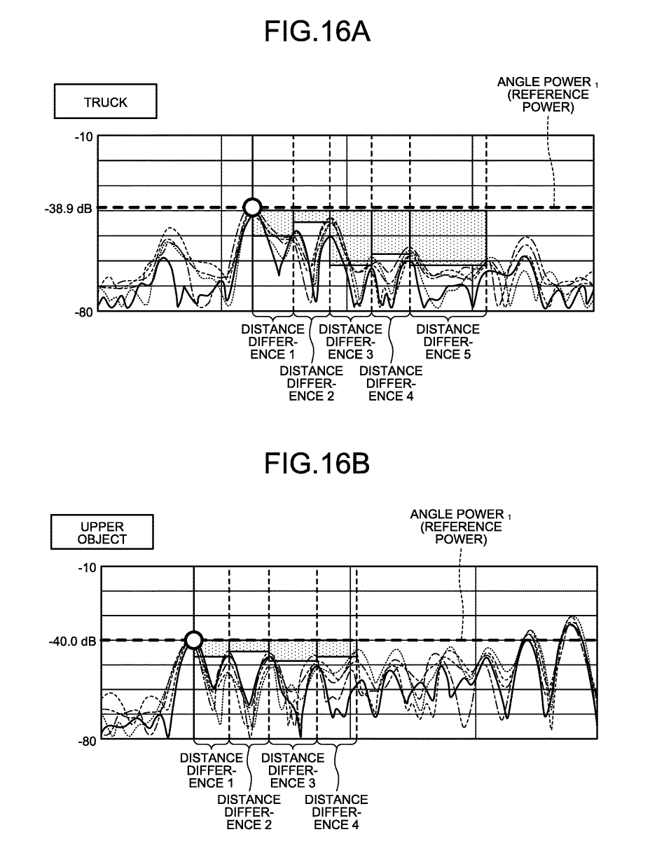

From the above, Equation (5) computes, as an “average reference power difference”, areas of hatched rectangles illustrated in FIG. 16A to calculate an average thereof. The case of FIG. 16B is similar to the above. In FIGS. 16A and 16B, its horizontal axis indicates a frequency and its vertical axis (angle) indicates a power. Therefore, as illustrated in FIGS. 16A and 16B, as compared to an upper object, because a truck tends to further decrease the angle power of a target as the truck is farther away from the reference target, it turns out that a likelihood that it is a truck is higher as the “average reference power difference” is larger, and a likelihood that it is an upper object is higher as the “average reference power difference” is smaller.

Score4 (average reference power difference) is computed from the average reference power difference model 63d illustrated in FIG. 17 and Equation (3-2). FIG. 17 is a diagram illustrating an average reference power difference model according to the first embodiment. The average reference power difference model 63d is a probability distribution model that indicates a relationship between an average reference power difference and a likelihood of each of the truck and upper object when its horizontal axis is an average reference power difference and its vertical axis is a likelihood. The probability distribution models of the truck and upper object illustrated in FIG. 15 are a model based on, for example, a normal distribution previously constructed by a maximum likelihood estimation method and an experimental design method. In the average reference power difference model 63d, a parameter characterizing a model is adjusted for each of the truck and upper object for the improvement of determination accuracy.

In FIG. 17, an average reference power difference model when the distance from the own vehicle A to the reference target is 80 m is illustrated as the average reference power difference model 63d. There is omitted the illustration of an average reference power difference model of each distance per 10 m from 10 m to 80 m and up to about 150 m from the viewpoint of the distance from the own vehicle A to the reference target.

For example, it is considered that an unbiased standard deviation is “−15”. In this case, referring to FIG. 17, when the unbiased standard deviation of the horizontal axis is “−15”, the likelihood of the truck of the vertical axis is about “0.064” and the likelihood of the upper object is about “0.031”. Therefore, assuming that n=4 in Equation (3-2), Score4 can be computed as Score4=log(truck likelihood 4)−log(upper-object likelihood 4)=log(0.064)−log(0.031).

Step 4: Discrimination Process Between Truck and Upper Object

The unnecessary target removing unit 76 performs threshold determination on Score computed in STEP 3 described above to determine whether a target object is a truck or an upper object. In other words, the unnecessary target removing unit 76 determines that the target object is a truck when Score is not less than a predetermined threshold, and determines that the target object is an upper object when it is less than the predetermined threshold.

Target Information Derivation Process According to First Embodiment

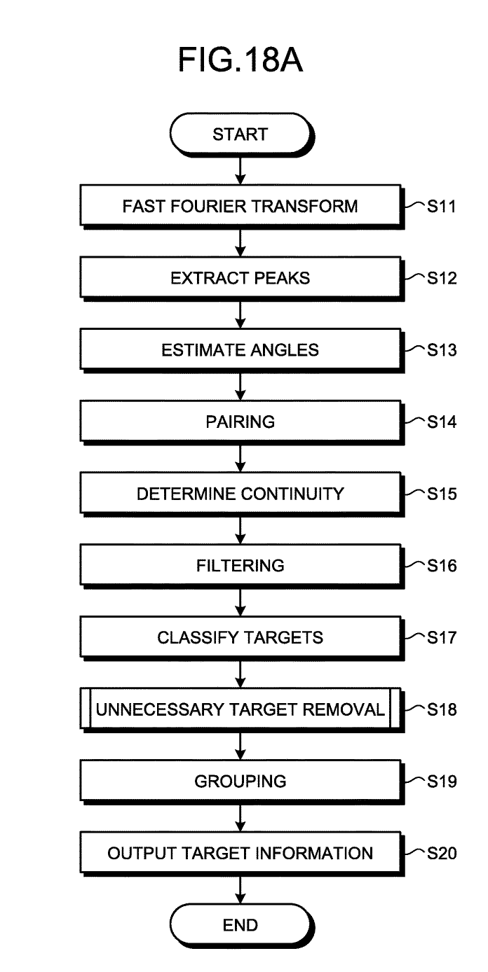

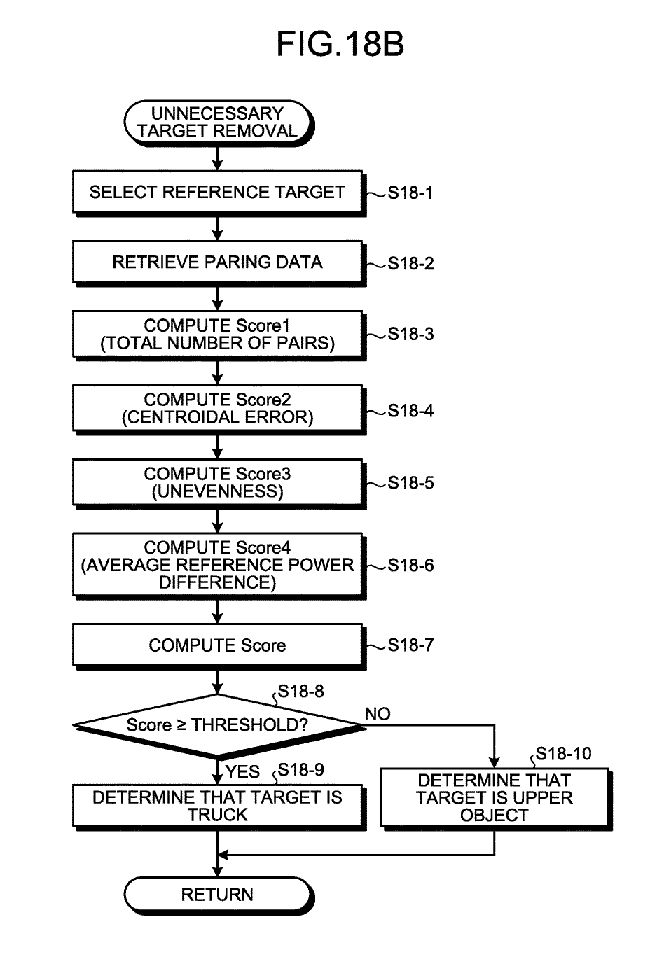

FIG. 18A is a flowchart illustrating a target information derivation process according to the first embodiment. The signal processing unit 6 periodically repeats a target information derivation process in a fixed time (for example, five milliseconds). At the start point of the target information derivation process, beat signals obtained by converting the reflected waves RW are input into the signal processing unit 6 from the four receiving units RX.

First, the Fourier transform unit 62 of the signal processing unit 6 performs fast Fourier transform on the beat signals output from the plurality of separate receiving units 52 (Step S11). Next, the peak extracting unit 70 extracts, from frequency spectra generated by the Fourier transform unit 62, peaks exceeding a predetermined signal level in an up zone in which the frequency of the transmitted signal rises and a down zone in which the frequency falls (Step S12).

Next, the angle estimating unit 71 derives information on a plurality of targets located at the same bin from a one-peak-frequency signal by using an azimuth calculation process for each of the up zone and down zone, and estimates angles of the plurality of targets (Step S13).

Next, the pairing unit 72 associates peaks related to the same target T with one another to derive target data related to each of the plurality of targets T that exists in front of the own vehicle A (Step S14). Next, the continuity determining unit 73 determines continuity of whether the target data derived by the past process and the target data derived by the recent process are the same target (Step S15).

Next, the filtering unit 74 smooths parameters (longitudinal distance, transverse distance, relative velocity) of two target data derived by the past process and the recent process in a time-axial direction so as to derive target data (internal filter data) (Step S16). Next, the target classifying unit 75 classifies targets into a leading vehicle, a stationary object (including stationary vehicle), and an oncoming vehicle on the basis of relative velocities (Step S17).

Next, the unnecessary target removing unit 76 determines, among the targets, an upper object, a lower object, rain, etc. as an unnecessary target, and removes the unnecessary target from output targets (Step S18). Moreover, in the process of Step S18, a process for removing an upper object from output targets will be described below with reference to FIG. 18B.

Next, the grouping unit 77 performs grouping for merging the plurality of target data into one as target data of the same object (Step S19). Next, the target information output unit 78 selects the predetermined number of target data as output targets from the plurality of target data derived or derived by extrapolation, and outputs the selected target data to the vehicle control device 2 (Step S20). When Step S20 is terminated, the signal processing unit 6 terminates the target information derivation process.

Unnecessary Target Removal According to First Embodiment

FIG. 18B is a flowchart illustrating a subroutine of the unnecessary target removal according to the first embodiment. In the unnecessary target removal of Step S18 illustrated in FIG. 18A, a flow of a process for removing an upper object according to the first embodiment is illustrated in FIG. 18B.

First, the unnecessary target removing unit 76 extracts a reference target equivalent to the rear end of a truck on the basis of the determination results of whether the conditions of (a1) to (a6) described above are satisfied (Step S18-1). Next, the unnecessary target removing unit 76 extracts pairing data (instantaneous value before filtering) of a stationary object located in the “vehicle body area” including the reference target extracted in Step S18-1 (Step S18-2).

Next, the unnecessary target removing unit 76 computes Score1 (total number of pairs) from the total-number-of-pairs model 63a and Equation (3-2) on the basis of the total number (total number of pairs) of pairing data extracted in Step S18-2 (Step S18-3). Next, the unnecessary target removing unit 76 computes Score2 (centroidal error) from the centroidal error model 63b and Equation (3-2) on the basis of the centroidal error computed by Equation (4-2) (Step S18-4).

Next, the unnecessary target removing unit 76 computes an unbiased standard deviation V that indicates an unevenness of pairing data extracted in Step S18-2, and computes Score3 (unevenness) from the unevenness model 63c and Equation (3-2) on the basis of the unbiased standard deviation V (Step S18-5). Next, the unnecessary target removing unit 76 computes Score4 (average reference power difference) from the average reference power difference model 63d and Equation (3-2) on the basis of the average reference power difference computed by Equation (5) (Step S16-8).

Next, the unnecessary target removing unit 76 computes Score from Score1 to Score4 computed in Steps S18-3 to S18-6 and Equation (3-1) (Step S18-7). Next, the unnecessary target removing unit 76 determines whether the Score computed in Step S18-7 is not less than a threshold value (Step S18-8). When the Score is not less than the threshold value (Step S18-8: Yes), the unnecessary target removing unit 76 determines that the target object is a truck (Step S18-9). On the other hand, when the Score is less than the threshold value (Step S18-8: No), the unnecessary target removing unit 76 determines that the target object is an upper object (Step S18-10). When Step S18-9 or Step S18-10 is terminated, the unnecessary target removing unit 76 moves the process to Step S19 of FIG. 18A.

Discrimination of Truck and Upper Object According to First Embodiment

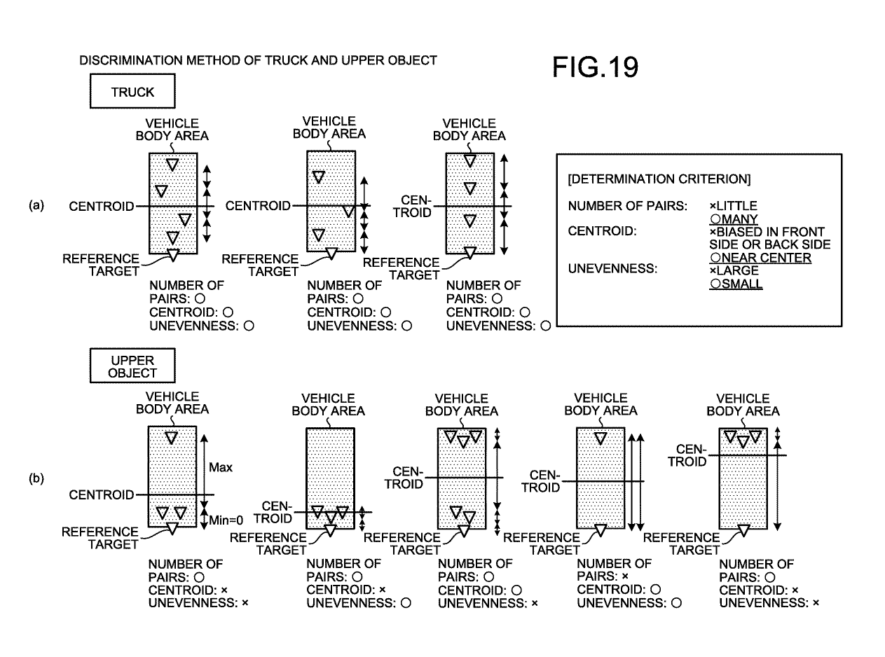

FIG. 19 is a diagram explaining discrimination of a truck and an upper object according to the first embodiment. In FIG. 19, “number of pairs: x” indicates that the total number of pairs of pairing data of the stationary object is less than a predetermined value (little), and “number of pairs: o” indicates that the total number of pairs is not less than the predetermined value (many). Moreover, “centroid: x” indicates that the “centroid” computed from Equation (4-1) is biased toward the front side (reference-target side in vehicle body area) or the back side (farthest side from reference target in vehicle body area), and “centroid: o” indicates that the “centroid” is located near the center of the front and back sides in the vehicle body area. Moreover, “unevenness: x” indicates that the unbiased standard deviation V described above is not less than a predetermined value (large), and “unevenness: o” indicates that the unbiased standard deviation V is less than the predetermined value (small).

As illustrated in (a) of FIG. 19, when the target object is a truck, any of “number of pairs”, “centroid”, and “unevenness” becomes “o”. On the other hand, as illustrated in (b) of FIG. 19, at least one of “number of pairs”, “centroid”, and “unevenness” becomes “x” when the target object is an upper object. Therefore, discrimination of whether the target object is a truck or an upper object can be performed on the basis of the sum of Score1 to Score4 obtained by adding Score4 to Score1 to Score3.

The first embodiment converts a likelihood whenever acquiring four parameters and determines, by using logit:log (truck likelihood/upper-object likelihood) obtained by performing Bayesian updating on this every time as a determination value, that the target object is a truck when the determination value is not less than the threshold value, and thus enhances the reliability of the truck. Therefore, according to the first embodiment, whether the target detected in the traveling direction of the own vehicle is a target (for example, a target that requires vehicle control such as brake control) to collide with the own vehicle can be determined precisely. Thus, a large-sized vehicle such as a truck and a trailer can be identified from a comparatively long distance (for example, about 80 m from the front of the target object) to improve a detection ratio, and vehicle control based on the target detection can be activated at an appropriate timing and by an appropriate instruction.

### Alternative Example of First Embodiment

About Probability Ratio Score

In the first embodiment, it is determined that the target object is a truck when Score is not less than the threshold value, and that the target object is an upper object when it is less than the threshold value. However, the first embodiment is not limited to this. When whether or not the target object is a truck is determined based on a comparison of “reliability of truck” and “threshold value”, Score may be converted and used by using a magnification C multiplied by “reliability of truck”. In other words, when “reliability of truck used for threshold determination=C×(reliability of truck)” is not less than the predetermined threshold, it is determined that this target object is a truck.

Herein, “reliability of truck” is an index, which indicates whether target data is data related to a truck, for example, which corresponds to a value within the range of 0-100, and has a higher possibility that the target object is a truck as the value of reliability is higher. “Reliability of truck” is computed by using multiple pieces of information (for example, “longitudinal distance”, “angle power”, “extrapolation frequency”, etc.) included in the target data.

For example, it is assumed that two threshold values of threshold 1>threshold 2 are provided. In case of Scorekthreshold 1, it is considered as the magnification C=1. In this case, because it can be determined that “reliability of truck” is high, this indicates that “reliability of truck” without change is used for the threshold determination of whether the target object is a truck. Moreover, in case of threshold 2≧Score, it is considered as the magnification C=0. In this case, because it can be determined that “reliability of truck” is low, “reliability of truck” becomes zero and thus this indicates that it is not determined that the target object is a truck.

In case of threshold 1>Score>threshold 2, it is considered as the magnification C=(Score−threshold 2)/(threshold 1−threshold 2). In other words, the magnification C indicates how much ratio Score exceeds threshold 2 between threshold 1 and threshold 2. For example, when it becomes C=0.5, this indicates that “reliability of truck used for threshold determination” obtained by multiplying 0.5 by “reliability of truck” is used for the threshold determination of whether the target object is a truck.

As described above, a margin of a determination of whether the target object is a truck is allowed by converting Score into the magnification C multiplied by “reliability of truck”, and thus the truck can be determined more comprehensively through the addition of various factors.

### Second Embodiment

Outline of Target Detection by Radar Device According to Second Embodiment

In the first embodiment, a large-sized vehicle such as a truck and a trailer is more precisely detected. However, in case of a large-sized vehicle having a structure that the rear end of a bus etc. extends up to the vicinity of a road surface, because beams cannot enter below the bus structurally, only a single peak can be detected and thus detection is difficult in the first embodiment. As a result, reliability for a target object is underestimated, and thus the detection can be performed in some cases at only an approach distance not more than 20 m, for example.

Therefore, the second embodiment focuses attention on that, in case of a large-sized vehicle such as a bus, a reflection level (angle power) is high, a specular point is stable, and the transition of an angle power when approaching a target object is characteristic. The second embodiment performs the determination of a bus and an upper object by using parameters obtained by quantifying the characteristics, and raises a reliability if it can be determined that the target object is a bus. In the following second embodiment, there is illustrated a case where a vehicle to be detected by a radar device is a bus. However, the second embodiment may be applied to a vehicle having radar reflection characteristics similar to the bus.

Angle Power and Distance of Bus and Upper Object

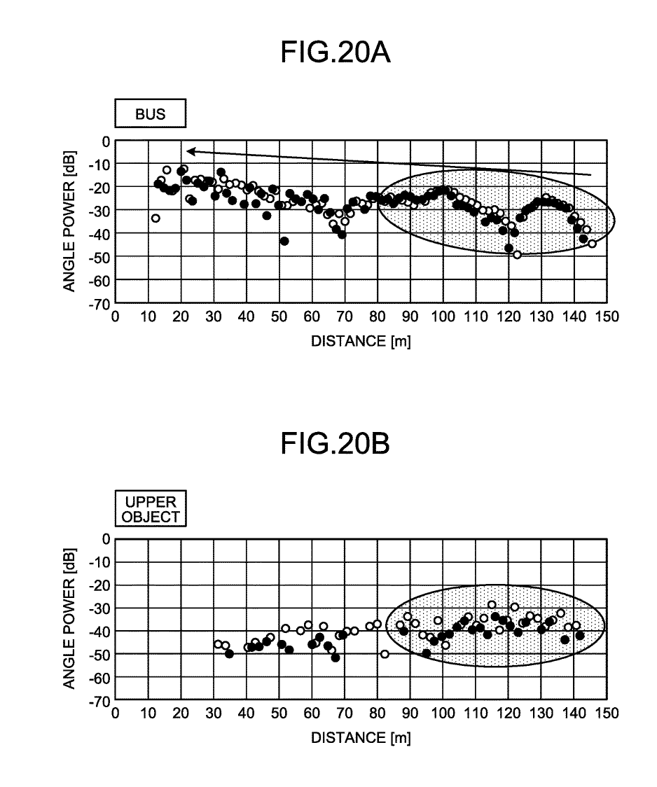

FIG. 20A is a diagram illustrating a relationship between an angle power and a distance of a bus. FIG. 20B is a diagram illustrating a relationship between an angle power and a distance of an upward object. The bus has the characteristics of the following (b1) to (b4) as compared to the upper object. An unnecessary target removing unit 76A (see FIG. 2) according to the second embodiment discriminates between a bus and an upper object on the basis of determination results of whether the conditions of the following (b1) to (b4) are satisfied.

(b1) An angle power tends to rise as a distance approaches (for example, a ration, at which an angle power difference obtained by subtracting an angle power at a second detection distance farther than a first detection distance from an angle power at the first detection distance is positive, is not less than a predetermined value).

(b2) Fluctuation every scanning at a long distance (for example, farther than about 80 m) is small (for example, fluctuation is not more than predetermined value).

(b3) An extrapolation frequency is low (for example, extrapolation ratio is not more than predetermined value).

(b4) The characteristic of convex Null of an angle power by multipath appears at a long distance (for example, farther than about 80 m). Herein, “convex Null” is an upward convex curved line in the neighborhood of a local maximum point and is a curved line taking a shape similar to the vicinity of a local minimum point of a cycloid curved line in the neighborhood of the local minimum point, for example.

The characteristic of (b1) can be read from FIG. 20A. The characteristic of (b2) can be read from the comparison of framed portions of FIGS. 20A and 20B. The characteristic of (b4) can be read from the framed portion of FIG. 20A.

Average Convex Null Power Computation

The large underlying characteristic for discriminating between the bus and upper object includes power variation (convex Null) by multipath in a distant place. In other words, convex points and Null points are gently observed for the bus (convex Null frequency is low), and a convex Null frequency is high due to strong impact of multipath for the upper object. In the second embodiment, a convex Null change amount (average convex Null power) at a unit distance is computed and used for threshold determination. The average convex Null power is computed by the following Equation (6).

Average convex Null power=Sum of Convex Null areas/Sum of Differences between previous and present distances (6)

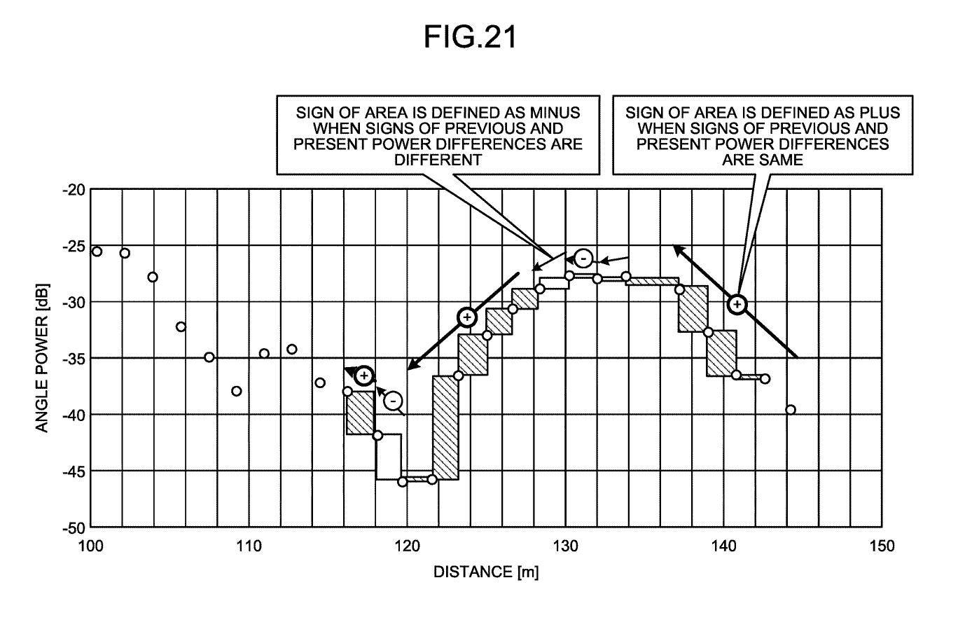

The computation of an average convex Null power will be explained with reference to FIG. 21. FIG. 21 is a diagram explaining average convex Null power computation according to the second embodiment. Whenever a target object approaches from a long distance to a short distance and its angle power is computed, a power difference between the present angle power and the previous angle power before once is computed. Then, a distance difference between the previous distance and the present distance is computed. Then, the power differences are multiplied by the distance differences. Each of the multiplication results is an area of each rectangle illustrated in FIG. 21. The area of each rectangle is called a “convex Null area”. The “convex Null area” can be computed by the following Equation (7).

Convex Null area=Difference between previous and present powers×Difference between previous and present distances (7)

When the signs of the previous power difference and the present power difference are the same (namely, it is not inflection point), the sign of “convex Null area” is defined as “plus (+)”. When the signs of the previous power difference and the present power difference are different (namely, it is inflection point), the sign of “convex Null area” is defined as “minus (−)” In FIG. 21, a rectangle indicating a “convex Null area” diagonally hatched is a “plus-sign convex Null area”. Moreover, a rectangle indicating a “convex Null area” without hatching is a “minus-sign convex Null area”.

A denominator of a right-hand side of Equation (6) is a cumulative value of distance differences between the previous distance and the present distance. Moreover, a numerator of the right-hand side of Equation (6) is a sum of all “convex Null areas” with signs. As in Equation (6), an “average convex Null power” is computed by dividing the sum of all the “convex Null areas” with signs by the cumulative value of distance differences between the previous distance and the present distance.

As described above, because the “average convex Null power” is plus when the signs of the previous power difference and the present power difference are the same and is minus when the signs are different (inflection point), an upper object having a high convex Null frequency is easy to take a negative value or a positive value near zero, and a bus is easy to take a positive value not less than a predetermined value. Therefore, discrimination between the bus and upper object can be performed by performing threshold determination on the “average convex Null power”. Moreover, the “average convex Null power” is computed at each timing of a timing, at which the radar device receives the reflected wave of the downward transmission wave TW1 and detects a target, and a timing at which the radar device receives the reflected wave of the upward transmission wave TW2 and detects a target. The “average convex Null power” computed at each timing is used for discrimination between the bus and upper object.

Unnecessary Target Removal According to Second Embodiment

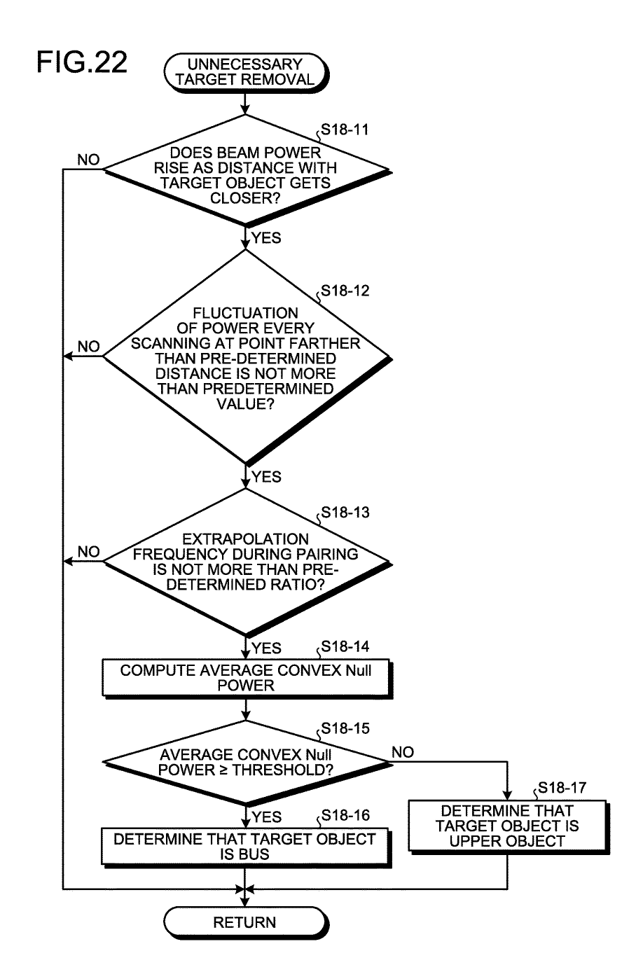

FIG. 22 is a flowchart illustrating a subroutine of unnecessary target removal according to the second embodiment. In the unnecessary target removal of Step S18 illustrated in FIG. 18A, a flow of a process for removing an upper object according to the second embodiment is illustrated in FIG. 22. The target information derivation process (see FIG. 18A) and an unnecessary target removal process (see FIG. 22) according to the second embodiment are performed by the unnecessary target removing unit 76A (see FIG. 2) according to the second embodiment. Moreover, the unnecessary target removing unit 76A is included in a data processing unit 7A of a signal processing unit 6A of a radar device 1A according to the second embodiment.

First, the unnecessary target removing unit 76A determines whether a beam power rises as a distance with a target object gets closer (Step S18-11). In other words, the unnecessary target removing unit 76A determines whether the condition of (b1) is satisfied. When the beam power rises as the distance with the target object gets closer (Step S18-11: Yes), the unnecessary target removing unit 76A moves the process to Step S18-12. On the other hand, when the beam power does not rise as the distance with the target object gets closer (Step S18-11: No), the unnecessary target removing unit 76A moves the process to Step S19 of FIG. 18A.

In Step S18-12, the unnecessary target removing unit 76A determines whether a fluctuation of power every scanning at a point farther than a predetermined distance is not more than a predetermined value. In other words, the unnecessary target removing unit 76A determines whether the condition of (b2) is satisfied. When the fluctuation of power every scanning at the point farther than the predetermined distance is not more than the predetermined value (Step S18-12: Yes), the unnecessary target removing unit 76A moves the process to Step S18-13. On the other hand, when the fluctuation of power every scanning at the point farther than the predetermined distance is larger than the predetermined value (Step S18-12: No), the unnecessary target removing unit 76A moves the process to Step S19 of FIG. 18A.

In Step S18-13, the unnecessary target removing unit 76A determines whether an extrapolation frequency during pairing is not more than a predetermined ratio. In other words, the unnecessary target removing unit 76A determines whether the condition of (b3) is satisfied. When the extrapolation frequency during pairing is not more than the predetermined ratio (Step S18-13: Yes), the unnecessary target removing unit 76A moves the process to Step S18-14. On the other hand, when the extrapolation frequency during pairing is larger than the predetermined ratio (Step S18-13: No), the unnecessary target removing unit 76A moves the process to Step S19 of FIG. 18A.

In Step S18-14, the unnecessary target removing unit 76A computes an “average convex Null power” from Equation (6). Next, the unnecessary target removing unit 76A determines whether the “average convex Null power” computed in Step S18-14 is not less than a threshold value (Step S18-15). When the “average convex Null power” is not less than the threshold value (Step S18-15: Yes), the unnecessary target removing unit 76A moves the process to Step S18-16. On the other hand, when the “average convex Null power” is less than the threshold value (Step S18-15: No), the unnecessary target removing unit 76A moves the process to Step S18-17.

In Step S18-16, the unnecessary target removing unit 76A determines that the target object is a bus. In Step S18-17, the unnecessary target removing unit 76A determines that the target object is an upper object. When Step S18-16 or S18-17 is terminated, the unnecessary target removing unit 76A moves the process to Step S19 of FIG. 18A.

The second embodiment performs discrimination between the bus and upper object by using parameters obtained by quantifying the characteristics of (b1) to (b4) of powers of the reflected waves of the bus, and raises a reliability if it can be determined that the target object is a bus. Therefore, according to the second embodiment, a large-sized vehicle such as a bus can be identified from a comparatively long distance (for example, about 80 m from target object) to improve a detection ratio, and thus vehicle control can be activated at an appropriate timing and by an appropriate instruction on the basis of the detection of the target object.

### Third Embodiment

Outline of Target Detection by Radar Device According to Third Embodiment

According to the third embodiment, a radar device detects a vehicle to be detected and an on-road object (hereinafter, called “lower object”) such as a manhole, a road sign, a grating located on a road from a comparatively long distance with high precision.

In other words, the existing on-road object determination is performed by monitoring fluctuation of a reception level (angle power) of a target object to discriminate between a stationary vehicle and a lower object. However, determination cannot be performed precisely depending on a mounting condition such as a mounting height and an elevation angle of a radar device and the shape of a target object, and thus a lower object may be incorrectly detected even at close range. Moreover, when adjusting the radar device so as not to incorrectly detect a lower object, there is a dilemma that a detection distance of a stationary vehicle becomes short.

Therefore, in the third embodiment, the discrimination between a stationary vehicle and a lower object can be performed by monitoring the size of an angle power, the change amount (amplification amount and attenuation amount) in an angle power by multipath, and the tendency of occurrence frequency of multipath. As a result, discrimination that does not depend on the mounting condition of radar device and the shape of target object becomes possible, and thus the stationary vehicle and lower object can be detected with high precision.

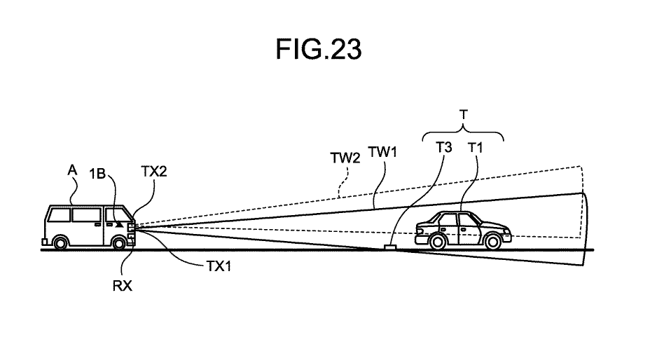

FIG. 23 is a schematic diagram illustrating the outline of target detection performed by a radar device 1B according to the third embodiment. The radar device 1B according to the third embodiment is mounted on the front region, such as a front grille, of the own vehicle A, for example, and detects the target T (targets T1 and T3) that exists in the traveling direction of the own vehicle A. The target T3 illustrated in FIG. 23 is, for example, a lower object, other than a vehicle, which downward remains stationary in the traveling direction of the own vehicle A. The others of the radar device 1B according to the third embodiment are similar to the radar device 1 according to the first embodiment.

Configuration of Radar Device According to Third Embodiment

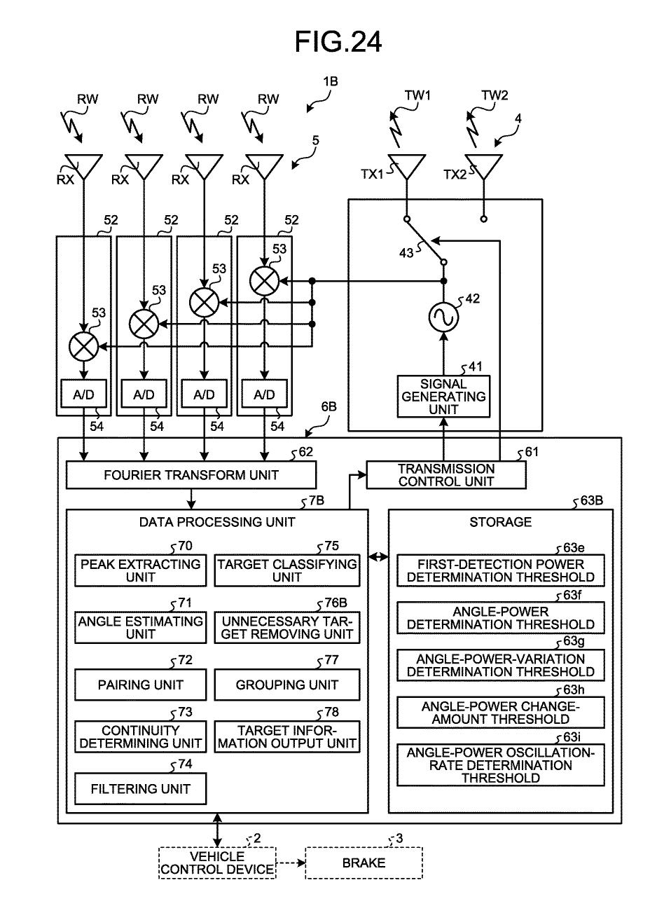

FIG. 24 is a diagram illustrating the configuration of the radar device 1B according to the third embodiment. As illustrated in FIG. 24, the radar device 1B according to the third embodiment includes a signal processing unit 6B and a storage 63B. The signal processing unit 6B includes an unnecessary target removing unit 76B. Moreover, the storage 63B stores therein a first-detection power determination threshold 63e, an angle-power determination threshold 63f, an angle-power-variation determination threshold 63g, an angle-power change-amount threshold 63h, and an angle-power oscillation-rate determination threshold 63i, which are described below. The other configuration of the radar device 1B according to the third embodiment is similar to the radar device 1 according to the first embodiment.

Discrimination Process of Vehicle and Lower Object According to Third Embodiment

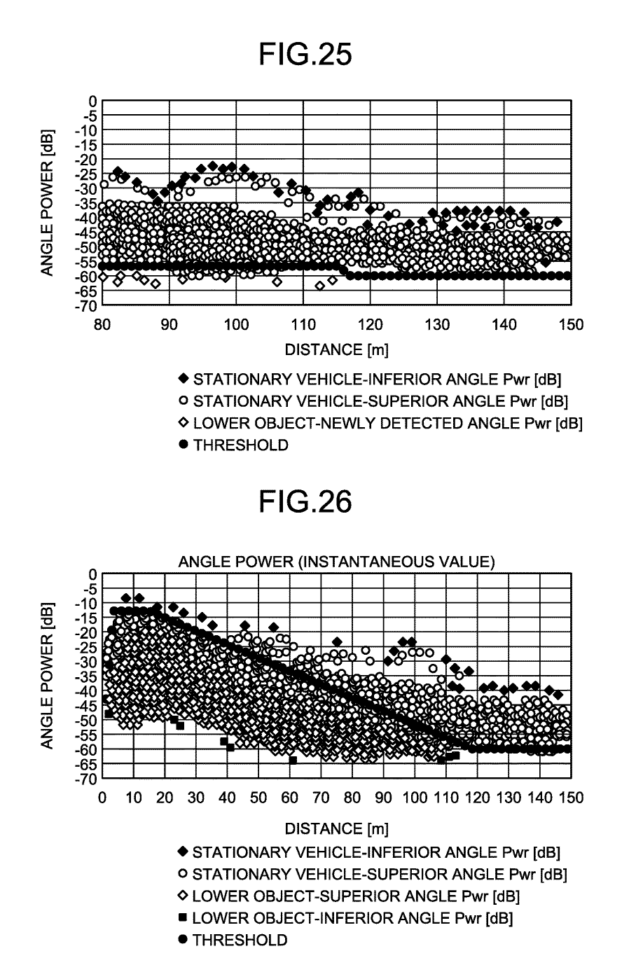

Hereinafter, the details of a discrimination process of the vehicle and lower object performed by the unnecessary target removing unit 76B according to the third embodiment will be explained in the order of STEP 1 to STEP 5 with reference to FIGS. 25 to 30. In the third embodiment, when it is assumed that a target object is a lower object in accordance with the determination of any of STEP 1 to STEP 5, it is determined that the target object is a lower object.

Step 1: First-Detection Angle-Power Determination

It is characterized that a reflection level of a lower object has the lowest level when it is newly detected and increases monotonically as its distance gets closer. In the third embodiment, when it can be determined that a target object is a target under a good environment for the radar device 1B under which a peripheral object such as a tunnel and a truss bridge does not exist, discrimination between the stationary vehicle and lower object is performed by using an angle power when it is newly detected at a long distance.

FIG. 25 is a diagram illustrating a relationship between a newly detected angle power and a distance. As can be seen from FIG. 25, a newly detected angle power of a lower object indicated with “⋄” is not more than −60 dB substantially at a distance not more than 130 m. Therefore, by setting a threshold value as indicated with “” in FIG. 25, it is determined that the target object whose newly detected angle power is not more than the threshold value is a lower object.

Step 2: Angle Power Determination

When it approaches a target object that remains stationary, tendencies of distance transition of a reflection level are different between a stationary vehicle and an on-road object as described below. In other words, an angle power (instantaneous value) of a reflected wave of a stationary vehicle has the repeated convexity (amplification) and Null (attenuation) due to the influence of multipath. On the other hand, an angle power of a reflected wave of a lower object increases simply due to small impact of multipath because the object does not have a height. An angle power (instantaneous value) is a calculated result of azimuth calculation obtained by dividing the result of FFT in the Fourier transform unit 62 (see FIG. 24) into angular directions of a target.

FIG. 26 is a diagram illustrating a relationship between an angle power (instantaneous value) and a distance. By setting a threshold value as indicated with “” in FIG. 26, the angle power of the reflected wave of a stationary vehicle that has the repeated convexity (amplification) and Null (attenuation) appears in a region greater than the threshold value. On the other hand, the simply-increasing angle power of the reflected wave of a lower object appears in a region not more than the threshold value indicated with “” in FIG. 26. Therefore, by setting the threshold value as indicated with “” in FIG. 26, it is determined that the target object whose angle power (instantaneous value) is not more than the threshold value is a lower object.

Step 3: Angle-Power Variation Determination

The computation of angle-power variation according to the third embodiment uses an existing technique. For example, an angle-power variation according to the third embodiment is computed similarly to the power variation used in Step S18-12 of the second embodiment. It is determined that the target object whose angle-power variation is not less than a threshold value is a lower object.

Step 4: Angle-Power Change-Amount Determination

An angle-power change-amount determination according to the third embodiment suppresses the output of a lower object by using the change amount (amplification amount+attenuation amount) in an angle power and detects a stationary vehicle. This is performed by using the fact that the change of a reflection level by multipath is different depending on the height of a target. The target-height of a stationary vehicle is larger than the target-height of a lower object.

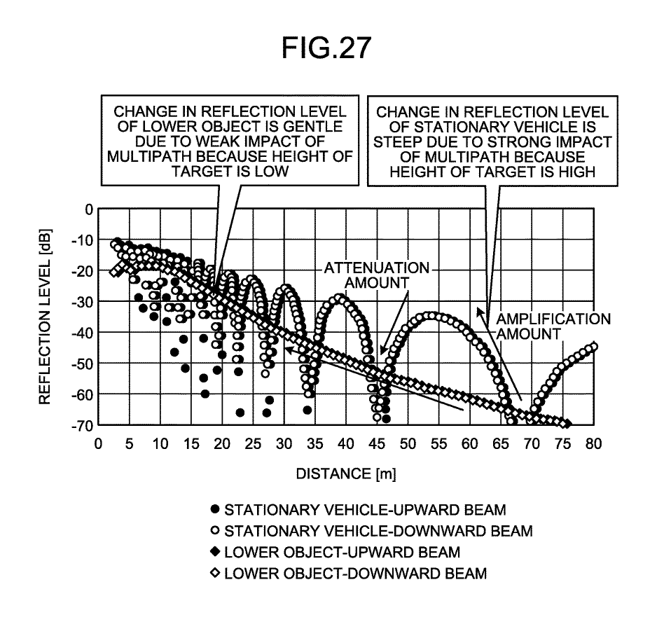

FIG. 27 is a diagram explaining the change in an angle power of a stationary vehicle and a lower object in a relationship between the change in an angle power and a distance in consideration of multipath. As can be seen from FIG. 27, a stationary vehicle indicates “convex Null” in which the change in a reflection level is steep due to the strong impact of multipath because the height of target is high. On the other hand, a lower object indicates monotonic increase in which the change in a reflection level is gentle due to the weak impact of multipath because the height of target is low. The angle-power change-amount determination includes STEP 4-1: angle-power difference computation and STEP 4-2: angle-power change-amount computation.

Step 4-1: Angle-Power Difference Computation

The radar device 1B according to the third embodiment alternately emits an upward beam and a downward beam every scanning. An angle-power difference is computed from the subtraction of the present angle power and the previous angle power for each of the upward and downward beams on the basis of Equation (8-2). At this time, because the excessive computation of power difference is prevented due to low S/N (Signal to Noise), the present angle power and the previous angle power of each of the upward and downward beams use a value not less than −55 dB, for example, as indicated by the condition of Equation (8-1).

$$\begin{matrix} 〈 Conditions 〉 & \\ AND \{ \begin{matrix}Complete extrapolation flag = OFF \\ Present angle power ( upward \text{/} downward beams ) \geq - 55 dB \\ Previous angle power ( upward \text{/} downward beams ) \geq - 55 dB\end{matrix} & ( 8 \text{-} 1 ) \\ 〈 Process 〉 & \\ Angle power difference ( upward \text{/} downward beams ) = Present angle power ( upward \text{/} downward beams ) - Previous angle power ( upward \text{/} downward beams ) & ( 8 \text{-} 2 )\end{matrix}$$

Step 4-2: Angle-Power Change-Amount Computation

A lower object is affected by the change in a specular point and multipath even though a frequency is low and may have fluctuated power, as compared to a stationary vehicle. Therefore, in consideration of a difference of frequency (probability), only when an angle-power difference not less than a certain level is computed, integration is made as an angle-power change amount.

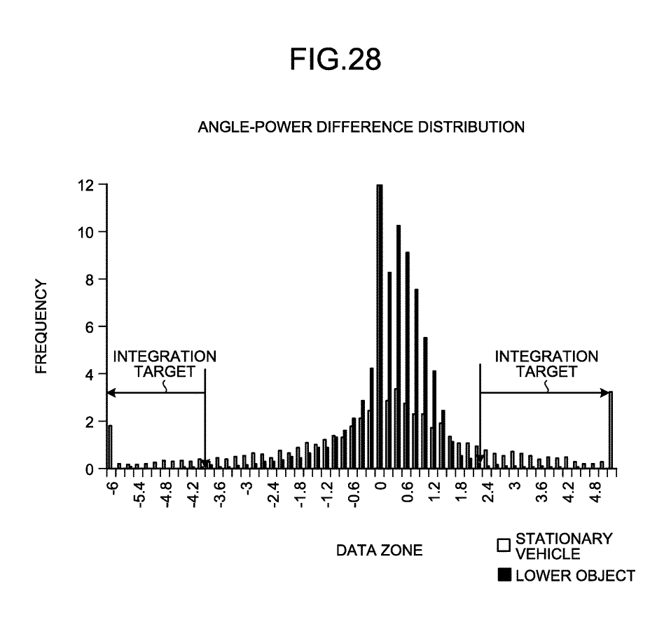

FIG. 28 is a diagram explaining angle-power change amount computation in an angle-power difference distribution according to the third embodiment. As can be seen from FIG. 28, the angle-power difference of a lower object has small distribution unevenness as compared to the angle-power difference of a stationary vehicle, and is substantially distributed within the range of [−4.0, 2.0]. However, the angle-power difference of the lower object is distributed slightly even within a range other than the range of [−4.0, 2.0]. Therefore, assuming that “−4.0” and “2.0” is border lines for the determination of whether they are the integration target of angle-power differences, for example, it is determined that a target object, for which the integrated value for angle-power differences distributed over the range of [−6.0, −4.0] and [2.0, 5.0] is not more than a threshold value, is a lower object.

Step 5: Angle-Power Oscillation Rate Determination

An angle-power oscillation rate determination according to the third embodiment suppresses the output of a lower object by using an oscillation rate (smoothness) of an angle power and detects a stationary vehicle. This is performed by using the fact that occurrence frequencies of power variation by multipath are different depending on the height of target when a distance with the target is near.

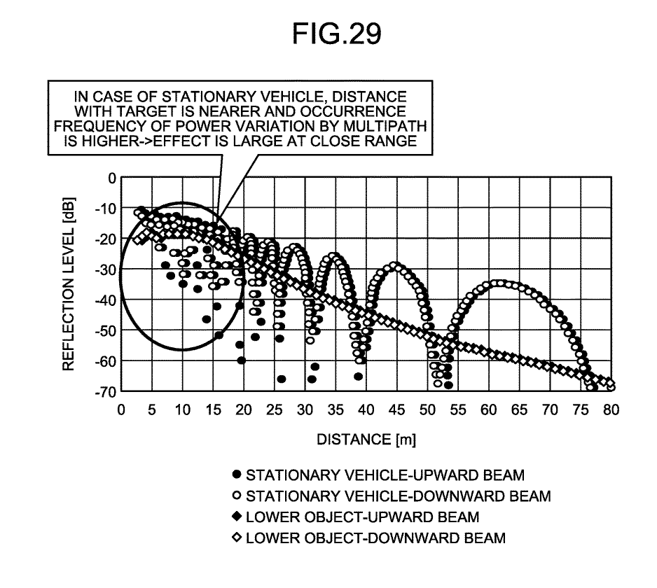

FIG. 29 is a diagram explaining the change in a variation of angle power of a stationary vehicle and a lower object in a relationship between the change in an angle power and a distance in consideration of multipath. The target-height of a stationary vehicle is larger than the target-height of a lower object. However, as illustrated in FIG. 29, in case of the stationary vehicle whose height is high, the distance with the target is nearer, and occurrence frequency of power variation by multipath is higher. The angle-power oscillation rate determination includes the following angle-power oscillation rate computation.

Angle-Power Oscillation Rate Computation

An angle-power oscillation rate is computed by using a difference between the previous angle power and an average value of the present angle power and the last-but-one angle power on the basis of Equations (9-2) and (9-3). The angle-power oscillation rate is computed for each of the upward and downward beams. Herein, as indicated by Equation (9-1), the present value, the previous value, and the last-but-one value are normally detected continuously, and each angle power is not less than −55 dB.

$$\begin{matrix} 〈 Conditions 〉 & \\ AND \{ \begin{matrix}Complete extrapolation flag = OFF \\ Present angle power \geq - 55 dB \\ There is previous angle power \\ Previous angle power \geq - 55 dB \\ There is last \text{-} but \text{-} one angle power \\ Last \text{-} but \text{-} one angle power \geq - 55 dB\end{matrix} & ( 9 \text{-} 1 ) \\ 〈 Process 〉 & \\ Reference angle power = \frac{Present angle power + Last \text{-} but \text{-} one angle power}{2} & ( 9 \text{-} 2 ) \\ Angle \text{-} power oscillation rate = Previous angle power - Reference angle power & ( 9 \text{-} 3 )\end{matrix}$$

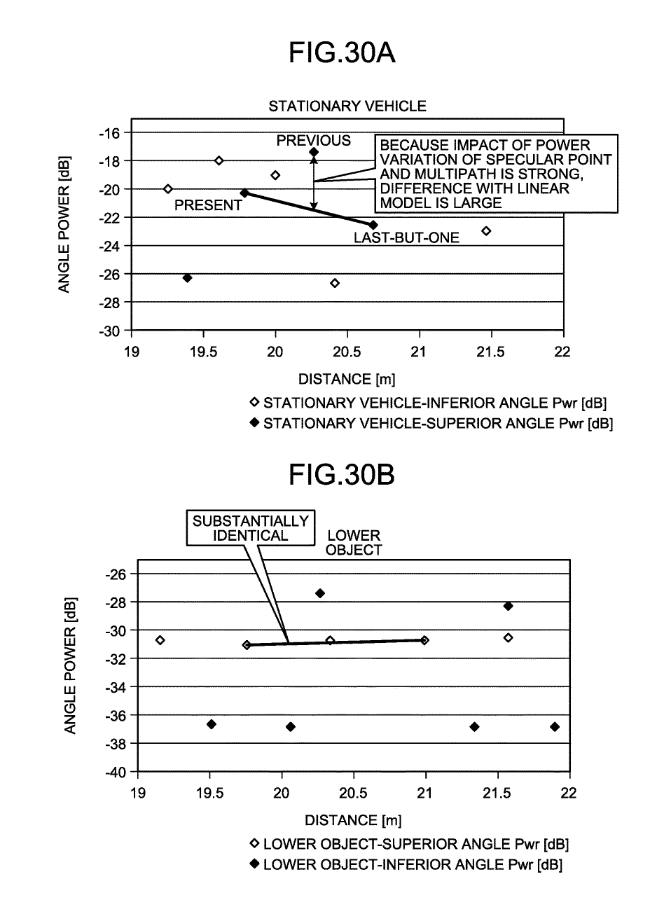

Next, the discrimination between the stationary vehicle and lower object uses a difference, namely a range, between the maximum and minimum values of the angle-power oscillation rates computed up to the present scanning. FIG. 30A is a diagram explaining stationary vehicle determination according to the third embodiment. FIG. 30B is a diagram explaining lower object determination according to the third embodiment. As illustrated in FIG. 30A, in case of a stationary vehicle, an interval of power variation by multipath is wide at long range and an interval of power variation is narrow at close range. As illustrated in FIG. 30B, in case of a lower object, an interval of power variation is narrow and has substantially the same regardless of a distance. It is determined that a target object whose angle-power oscillation rate is not more than a threshold value is a lower object.

Unnecessary Target Removal According to Third Embodiment

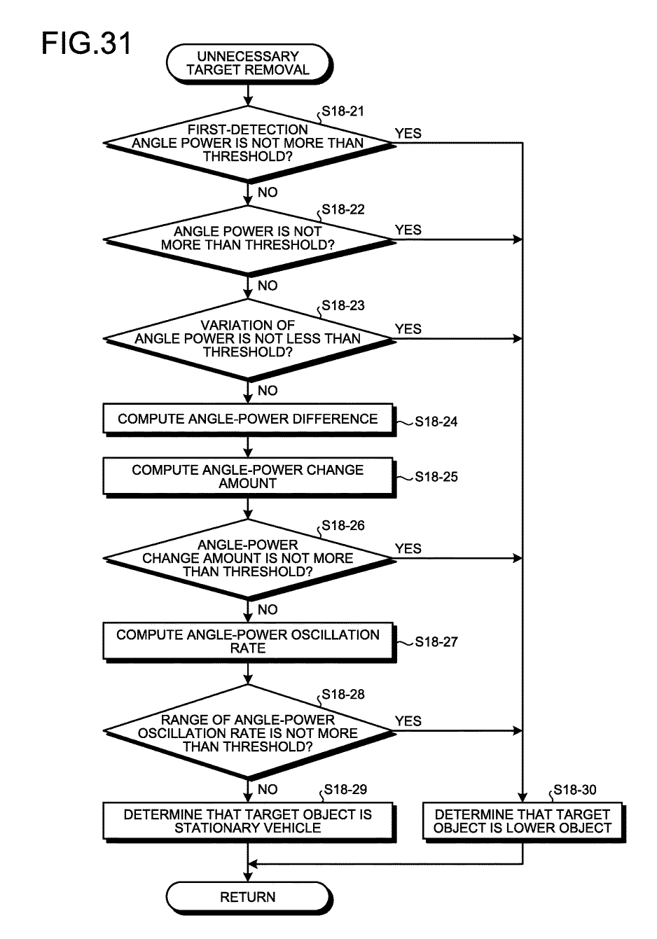

FIG. 31 is a flowchart illustrating a subroutine of the unnecessary target removal according to the third embodiment. In the unnecessary target removal of Step S18 illustrated in FIG. 18A, a flow of a process for removing a lower object according to the third embodiment is illustrated in FIG. 31. The target information derivation process (see FIG. 18A) and an unnecessary target removal process (see FIG. 31) according to the third embodiment are performed by the unnecessary target removing unit 76B (see FIG. 24) according to the third embodiment.

First, the unnecessary target removing unit 76B determines whether a first-detection angle power is not more than a threshold value (Step S18-21). In other words, the unnecessary target removing unit 76B performs the first-detection angle-power determination of STEP 1. When the first-detection angle power is not more than the threshold value (Step S18-21: Yes), the unnecessary target removing unit 76B moves the process to Step S18-30. On the other hand, when the first-detection angle power is larger than the threshold value (Step S18-21: No), the unnecessary target removing unit 76B moves the process to Step S18-22.

In Step S18-22, the unnecessary target removing unit 76B determines whether an angle power is not more than a threshold value. In other words, the unnecessary target removing unit 76B performs the angle power determination of STEP 2. When the angle power is not more than the threshold value (Step S18-22: Yes), the unnecessary target removing unit 76B moves the process to Step S18-30. On the other hand, when the angle power is larger than the threshold value (Step S18-22: No), the unnecessary target removing unit 76B moves the process to Step S18-23.

In Step S18-23, the unnecessary target removing unit 76B determines whether a variation of angle power is not less than a threshold value. In other words, the unnecessary target removing unit 76B performs the angle-power variation determination of STEP 3. When the variation of angle power is not less than the threshold value (Step S18-23: Yes), the unnecessary target removing unit 76B moves the process to Step S18-30. On the other hand, when the variation of angle power is larger than the threshold value (Step S18-23: No), the unnecessary target removing unit 76B moves the process to Step S18-24.

In Step S18-24, the unnecessary target removing unit 76B computes an angle-power difference. In other words, the unnecessary target removing unit 76B performs the angle-power difference computation of STEP 4-1. Next, the unnecessary target removing unit 76B computes an angle-power change amount (Step S18-25). In other words, the unnecessary target removing unit 76B performs the angle-power change-amount computation of STEP 4-2.

Next, the unnecessary target removing unit 76B determines whether the angle-power change amount is not more than a threshold value (Step S18-26). In other words, the unnecessary target removing unit 76B performs the angle-power change-amount determination of STEP 4. When the angle-power change amount is not more than the threshold value (Step S18-26: Yes), the unnecessary target removing unit 76B moves the process to Step S18-30. On the other hand, when the angle-power change amount is larger than the threshold value (Step S18-26: No), the unnecessary target removing unit 76B moves the process to Step S18-27.

In Step S18-27, the unnecessary target removing unit 76B computes an angle-power oscillation rate. Next, the unnecessary target removing unit 76B determines whether a range of the angle-power oscillation rate computed in Step S18-27 is not more than a threshold value (Step S18-29). When the range of the angle-power oscillation rate is not more than the threshold value (Step S18-28: Yes), the unnecessary target removing unit 76B moves the process to Step S18-30. On the other hand, when the range of the angle-power oscillation rate is larger than the threshold value (Step S18-28: No), the unnecessary target removing unit 76B moves the process to Step S18-29.

In Step S18-29, the unnecessary target removing unit 76B determines that the target object is a stationary vehicle. On the other hand, in Step S18-30, the unnecessary target removing unit 76B determines that the target object is a lower object. When Step S18-29 or Step S18-30 is terminated, the unnecessary target removing unit 76B moves the process to Step S19 of FIG. 18A.

Mutually Complementary Relationship of Discrimination Between Stationary Vehicle and Lower Object According to Third Embodiment

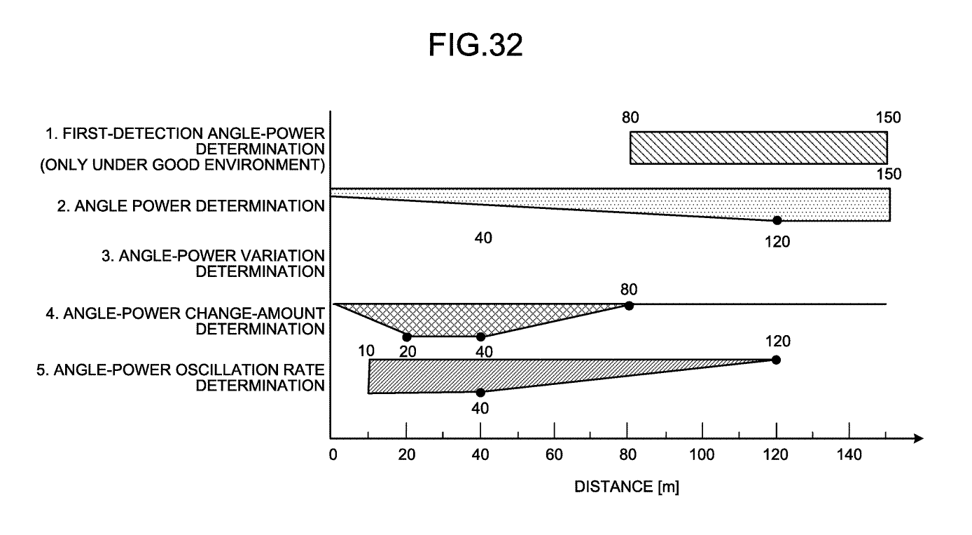

FIG. 32 is a diagram illustrating a mutually complementary relationship of discrimination between the stationary vehicle and lower object according to the third embodiment. The up-and-down widths of graphs, of “1. First-detection angle-power determination”, “2. Angle power determination”, “4. Angle-power change-amount determination”, and “5. Angle-power oscillation rate determination” as illustrated in FIG. 32, indicate the effectiveness of lower object determination at each distance. Moreover, in case of “3. Angle-power variation determination”, the effectiveness of discrimination between the stationary vehicle and lower object is constant regardless of a detection distance.

According to FIG. 32, for example, “1. First-detection angle-power determination” indicates that there is the substantially constant effectiveness of discrimination between the stationary vehicle and lower object at the first-detected distance from 150 to 80 meters but there is not the effectiveness of discrimination at the first-detected distance less than 80 meters. Moreover, for example, “2. Angle power determination” indicates that there is the substantially constant effectiveness of discrimination between the stationary vehicle and lower object at the detection distance from 150 to 120 meters but the effectiveness of discrimination at the detection distance from 120 to 0 meters decreases gradually.

For example, “4. Angle-power change-amount determination” indicates that there is not the effectiveness of discrimination between the stationary vehicle and lower object at the detection distance from 150 to 80 meters, but indicates that the effectiveness of discrimination at the detection distance from 80 to 40 meters gradually rises, the effectiveness of discrimination at the detection distance from 40 to 20 meters is substantially constant, and the effectiveness of discrimination at the detection distance from 20 to 0 meters gradually decreases.

For example, “5. Angle-power oscillation rate determination” indicates that there is not the effectiveness of discrimination between the stationary vehicle and lower object at the detection distance from 150 to 120 meters, but indicates that the effectiveness of discrimination at the detection distance from 120 to 40 meters gradually rises, the effectiveness of discrimination at the detection distance from 40 to 10 meters is substantially constant, and there is not the effectiveness of discrimination at the detection distance from 10 to 0 meters.

Therefore, according to FIG. 32, by using together the five determinations of “1. First-detection angle-power determination”, “2. Angle power determination”, “3. Angle-power variation determination”, “4. Angle-power change-amount determination”, and “5. Angle-power oscillation rate determination”, it is determined which of the stationary vehicle and lower object is a target object by any of the determinations. If the target object is assumed to be a stationary vehicle or a lower object on the basis of the determination result, it turns out that distances at which discrimination of the stationary vehicle and lower object by determination methods is effective are mutually complemented and thus discrimination between the stationary vehicle and lower object can be performed with higher precision.

For example, as illustrated in FIG. 32, the five determinations of “1. First-detection angle-power determination”, “2. Angle power determination”, “3. Angle-power variation determination”, “4. Angle-power change-amount determination”, and “5. Angle-power oscillation rate determination” are performed in this order. As a result, it turns out that discrimination between the stationary vehicle and lower object can be performed from any long distance and discrimination between the stationary vehicle and lower object can be performed with high precision up to any intermediate to short distances.

In the third embodiment, the determination of the stationary vehicle and lower object is performed on the basis of the size of angle power, the change amount (amplification amount and attenuation amount) in angle power by multipath, and a tendency of occurrence frequency of multipath. Therefore, according to the third embodiment, robustness for the size and type of a lower object, the detection distance of the lower object, the mounting height and elevation angle of a radar device, and the fluctuation of its own vehicle velocity etc. is improved, and thus the stationary vehicle and lower object can be identified from a comparatively long distance (for example, about 150 m from target object) and a detection ratio is improved. Accordingly, vehicle control can be activated at an appropriate timing and by an appropriate instruction on the basis of the detection of the target object.

The aforementioned peak extracting unit 70, the angle estimating unit 71, the pairing unit 72 and the continuity determining unit 73 is one example of a deriving unit. The unnecessary target removing unit 76 is one example of a determination unit. The stationary vehicle is one example of a target (for example, target needing vehicle control such as brake control) with which, for example, the own vehicle is to collide, and the upper object is one example of a target (for example, target not needing vehicle control such as brake control) with which, for example, the own vehicle is not to collide.

In the meantime, among the processes described in the present embodiments, the whole or a part of processes that have been automatically performed can be manually performed. Alternatively, the whole or a part of processes that have been manually performed can be automatically performed in a well-known method.

The integration and dispersion of the components described in the present embodiments can be arbitrarily changed depending on a processing load and a processing efficiency. Also, processing procedures, control procedures, concrete titles, and information including various types of data and parameters, which are described in the document and the drawings, can be arbitrarily changed except that they are specially mentioned.

According to an example of embodiments of the present application, it is possible to discriminate between a stationary vehicle and an object other than a stationary vehicle with high precision, for example.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A radar device comprising:
a deriving unit that derives, based on a received signal acquired by receiving a reflected wave obtained by reflecting a radar transmission wave transmitted to a periphery of an own vehicle on a target located on the periphery, a parameter related to the target and a detection distance of the target; and
a determining unit that determines, from a given characteristic of the parameter and the parameter and the detection distance derived by the deriving unit, whether the target existing in a traveling direction of the own vehicle is a target that collides with the own vehicle when the own vehicle advances in the traveling direction or a target that does not collide with the own vehicle when the own vehicle advances in the traveling direction.

2. The radar device according to claim 1, wherein
the target that collides with the own vehicle is a vehicle target related to a stationary vehicle within its own lane,
the target that does not collide with the own vehicle is an upper target related to an upper object within its own lane,
the deriving unit derives: as the parameter derived whenever the received signal is acquired,
a first parameter related to a number of targets included in a planar region of a vehicle body of the stationary vehicle including a reference target corresponding to a rear end of the vehicle body among the targets;
a second parameter related to a centroid of positions of the targets included in the planar region;
a third parameter related to an unevenness of the positions of the targets included in the planar region; and
a fourth parameter related to an average of angle-power differences between the reference target and the targets included in the planar region, and
the determining unit determines whether the target is the vehicle target or the upper target by using the first to fourth parameters.

3. The radar device according to claim 1, wherein
the target that collides with the own vehicle is a vehicle target related to a stationary vehicle within its own lane,
the target that does not collide with the own vehicle is an upper target related to an upper object within its own lane,
the deriving unit derives: as the parameter derived whenever the received signal is acquired,
a first parameter related to angle powers of the target;
a second parameter related to an unevenness of the angle powers of the target;
a third parameter related to a ratio of detection abnormality when the target is detected based on the received signal; and
a fourth parameter related to a difference between reception powers of previous and present acquisitions of the target, and
the determining unit determines whether the target is the vehicle target or the upper target from the first to fourth parameters and each the detection distance derived by the deriving unit and given characteristics of the parameters that are different depending on whether a discrimination target is the vehicle target or the upper target in accordance with the detection distance.

4. The radar device according to claim 1, wherein
the target that collides with the own vehicle is a vehicle target related to a stationary vehicle within its own lane,
the target that does not collide with the own vehicle is an on-road target related to an on-road object,
the deriving unit derives: as the parameter derived whenever the received signal is acquired,
a first parameter related to angle powers of the target;
a second parameter related to an unevenness of the angle powers of the target; and
a third parameter related to an oscillation rate of each of the angle powers of the target, and
the determining unit determines that the target is the on-road target when the first to third parameters and each the detection distance derived by the deriving unit are identical with at least one of given characteristics of the parameters that are different depending on whether a discrimination target is the vehicle target and the on-road target in accordance with the detection distance, and determines that the target is the vehicle target when the first to third parameters and each the detection distance are not identical with any of the given characteristics.

5. A control method of a radar device that is executed by a control device of the radar device, the control method comprising:
deriving, based on a received signal acquired by receiving a reflected wave obtained by reflecting a radar transmission wave transmitted to a periphery of an own vehicle on a target located on the periphery, a parameter related to the target and a detection distance of the target; and
determining, from a given characteristic of the parameter and the parameter and the detection distance derived in the deriving, whether the target existing in a traveling direction of the own vehicle is a target that collides with the own vehicle when the own vehicle advances in the traveling direction or a target that does not collide with the own vehicle when the own vehicle advances in the traveling direction.
